(19) United States
(12) Patent Application Publication
(10) Pub. No.: US 2026/0173120 A1
(43) Pub. Date: Jun. 18, 2026

(54) SIDELINK RESOURCE SELECTION IN ACCORDANCE WITH A FLEXIBLE PARAMETER CONFIGURATION

(71) Applicant: QUALCOMM Incorporated, San Diego, CA (US)

(72) Inventors: Sourjya DUTTA, Jersey City, NJ (US); Gabi SARKIS, San Diego, CA (US); Tien Viet NGUYEN, Bridgewater, NJ (US); Kapil GULATI, Belle Mead, NJ (US); Hong CHENG, Basking Ridge, NJ (US); Qing LI, Princeton Junction, NJ (US)

(21) Appl. No.: 18/985,313

(22) Filed: Dec. 18, 2024

(51) Int. Cl. H04W 72/40

(52) U.S. Cl. CPC H04W 72/40

(57) ABSTRACT

Various aspects of the present disclosure generally relate to wireless communication. In some aspects, a first user equipment (UE) may obtain configuration information that includes a flexible parameter associated with selecting resources for sidelink communications, where the flexible parameter may be associated with a plurality of parameter values. The first UE may transmit, to a second UE, a sidelink message via a set of sidelink resources. In some examples, the set of sidelink resources may be selected in accordance with a parameter value from the plurality of parameter values. In some examples, the parameter value is based on data associated with a sidelink environment and one or more key performance indicators (KPIs) associated with the sidelink environment. Numerous other aspects are described.

### FIELD OF THE DISCLOSURE

Aspects of the present disclosure generally relate to wireless communication and specifically relate to techniques, apparatuses, and methods associated with sidelink resource selection in accordance with a flexible parameter configuration.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples of wireless communications, one or more user equipments (UEs) may communicate via sidelink operations. For example, sidelink communication enables direct device-to-device (D2D) communication, bypassing the wireless traffic that otherwise passes through a network node. Such sidelink capability may be applicable to wireless communication networks, such as vehicle-to-everything (V2X), public safety, and IoT scenarios. Sidelink communication may be associated with one or more different sidelink modes (e.g., Mode 1 and Mode 2). In Mode 1, sidelink resources are scheduled by the network node, offering centralized control to ensure efficient resource allocation, reduced collisions, and better coordination in areas with network coverage, such as urban or high-density environments. In contrast, Mode 2 enables UEs to autonomously select and manage sidelink resources in a distributed manner, enabling communication between multiple UEs without direct network coverage.

### SUMMARY

Some aspects described herein relate to a first user equipment (UE) for wireless communication. The first UE may include one or more memories and one or more processors coupled to the one or more memories. The one or more processors may be configured to obtain configuration information that includes a flexible parameter associated with selecting resources for sidelink communications, wherein the flexible parameter is associated with a plurality of parameter values. The one or more processors may be configured to transmit, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more key performance indicators (KPIs) associated with the sidelink environment.

Some aspects described herein relate to a network node for wireless communication. The network node may include one or more memories and one or more processors coupled to the one or more memories. The one or more processors may be configured to transmit, to a UE, configuration information that includes a flexible parameter associated with selecting resources for sidelink communications, wherein the flexible parameter is associated with a plurality of parameter values. The one or more processors may be configured to transmit, to the UE, a request to indicate one or more KPIs used by the UE to select a parameter value from the plurality of parameter values associated with the flexible parameter.

Some aspects described herein relate to a method of wireless communication performed by a first UE. The method may include obtaining configuration information that includes a flexible parameter associated with selecting resources for sidelink communications, wherein the flexible parameter is associated with a plurality of parameter values. The method may include transmitting, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more KPIs associated with the sidelink environment.

Some aspects described herein relate to a method of wireless communication performed by a network node. The method may include transmitting, to a UE, configuration information that includes a flexible parameter associated with selecting resources for sidelink communications, wherein the flexible parameter is associated with a plurality of parameter values. The method may include transmitting, to the UE, a request to indicate one or more KPIs used by the UE to select a parameter value from the plurality of parameter values associated with the flexible parameter.

Some aspects described herein relate to a non-transitory computer-readable medium that stores a set of instructions for wireless communication by a first UE. The set of instructions, when executed by one or more processors of the first UE, may cause the first UE to obtain configuration information that includes a flexible parameter associated with selecting resources for sidelink communications, wherein the flexible parameter is associated with a plurality of parameter values. The set of instructions, when executed by one or more processors of the first UE, may cause the first UE to transmit, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more KPIs associated with the sidelink environment.

Some aspects described herein relate to a non-transitory computer-readable medium that stores a set of instructions for wireless communication by a network node.

The set of instructions, when executed by one or more processors of the network node, may cause the network node to transmit, to a UE, configuration information that includes a flexible parameter associated with selecting resources for sidelink communications, wherein the flexible parameter is associated with a plurality of parameter values. The set of instructions, when executed by one or more processors of the network node, may cause the network node to transmit, to the UE, a request to indicate one or more KPIs used by the UE to select a parameter value from the plurality of parameter values associated with the flexible parameter.

Some aspects described herein relate to an apparatus for wireless communication. The apparatus may include means for obtaining configuration information that includes a flexible parameter associated with selecting resources for sidelink communications, wherein the flexible parameter is associated with a plurality of parameter values. The apparatus may include means for transmitting, to a UE, a sidelink message via a set of sidelink resources, wherein the set of sidelink resources is selected in accordance with a parameter value from the plurality of parameter values, wherein the parameter value is based at least in part on data associated with a sidelink environment and one or more KPIs associated with the sidelink environment.

Some aspects described herein relate to an apparatus for wireless communication. The apparatus may include means for transmitting, to a UE, configuration information that includes a flexible parameter associated with selecting resources for sidelink communications, wherein the flexible parameter is associated with a plurality of parameter values. The apparatus may include means for transmitting, to the UE, a request to indicate one or more KPIs used by the UE to select a parameter value from the plurality of parameter values associated with the flexible parameter.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of coordination signaling, in accordance with the present disclosure.

FIG. 6 is a diagram illustrating an example of sidelink resource selection, in accordance with the present disclosure.

FIG. 7 is a diagram illustrating an example associated with sidelink resource selection associated with a flexible parameter configuration, in accordance with the present disclosure.

FIG. 8 is a diagram illustrating an example associated with sidelink resource selection associated with a flexible parameter, in accordance with the present disclosure.

FIG. 9 is a diagram illustrating an example associated with sidelink resource selection associated with a flexible parameter, in accordance with the present disclosure.

FIG. 10 is a diagram illustrating an example process performed, for example, at a first user equipment (UE) or an apparatus of a first UE, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of wireless communications, one or more user equipments (UEs) may communicate via sidelink operations. For example, sidelink enables direct device-to-device (D2D) communication, bypassing the wireless traffic that otherwise would pass through a network node. Such sidelink capability may be applicable to wireless communication networks, such as vehicle-to-everything (V2X), public safety, and internet-of-things (IoT) scenarios. Sidelink communication may be associated with one or more different sidelink modes (e.g., Mode 1 and Mode 2). In Mode 1, sidelink resources are scheduled by the network node, offering centralized control to ensure efficient resource allocation, reduced collisions, and better coordination in areas with network coverage, such as urban or high-density environments. In contrast, Mode 2 enables UEs to autonomously select and manage sidelink resources in a distributed manner, enabling communication between multiple UEs without direct network coverage. Therefore, Mode 1 and Mode 2 in sidelink provide support for a range of use cases while ensuring reliable and efficient direct communication between UEs.

In some examples of Mode 2 sidelink communication, a UE may perform contention-based sidelink resource selection to select sidelink resources for the transmission of sidelink messages (e.g., a physical sidelink shared channel (PSSCH) message, a physical sidelink control channel (PSCCH) message, and/or a physical sidelink feedback channel (PSFCH) message). For instance, in Mode 2, the UE selects resources for sidelink transmissions and/or retransmissions from a shared resource pool that is accessible to multiple UEs. The UE may evaluate various factors, such as interference levels, historical resource usage, and collision probabilities, to identify suitable sidelink resources. Additionally, the UE may leverage sensing mechanisms to monitor the activity of other UEs and avoid resources that are currently occupied or frequently used, thereby reducing the risk of collisions.

In some examples, the UE may use one or more configured parameters to evaluate which sidelink resources to select in accordance with Mode 2 sidelink resource selection. For example, the UE may be configured with the one or more parameters via configuration signaling from a network node (e.g., radio resource control (RRC) signaling) or may be preconfigured with the one or more parameters (e.g., an original equipment manufacturer (OEM) configuration). Therefore, the UE may operate in accordance with the configured parameters to perform sidelink resource selection in Mode 2. In some cases, under different channel and/or traffic conditions, different configurations of the one or more parameters may result in increased sidelink communication performance at the UE. However, predicting respective values for the one or more parameters that balance trade-offs and suit the sidelink network may be associated with intensive system simulation. Additionally, such system simulations may also be limited in scope by underlying assumptions that may not be replicated in a real-world deployment of a sidelink network. Additionally, the decentralized nature of a sidelink system and/or changes to the sidelink system associated with mobility of multiple UEs may increase complexity of a network node individually configuring each UE of the sidelink network with up-to-date parameters for use in the Mode 2 sidelink resource selection.

Various aspects relate generally to sidelink resource selection in accordance with a flexible parameter configuration. Some aspects more specifically relate to the UE obtaining configuration information that includes one or more flexible parameters, each associated with selecting resources for sidelink communications, where the one or more flexible parameters are respectively associated with one or more of a plurality of parameter values. In some aspects, the UE may use an associated inference model (e.g., an artificial intelligence or machine learning (AI/ML) model) to obtain values to select for each of the one or more flexible parameters. For instance, the UE may input, into the inference model, data associated with the sidelink environment, input one or more key performance indicators (KPIs), and input a plurality of parameter values associated with a flexible parameter. Accordingly, the UE may obtain, from the inference model, a parameter value from the plurality of parameter values based on the data associated with the sidelink environment and the one or more KPIs. In some aspects, the UE may collect the data associated with the sidelink environment via one or more associated sensors and/or from other UEs associated with the sidelink environment. In some aspects, the one or more KPIs may be selected by the UE and may be associated with one or more of a quality of service metric, a data throughput metric, a channel occupancy metric, a link reliability metric, or a latency metric.

Particular aspects of the subject matter described in this disclosure can be implemented to realize one or more of the following potential advantages. In some examples, the described techniques can be used to increase reliability of sidelink communications in a dynamic sidelink environment. For example, the UE may use the one or more flexible parameters to dynamically update operations of Mode 2 sidelink resource selection as the sidelink environment changes. Such updates to operations of sidelink resource selection may enable the UE to transmit sidelink messages with an increase in packet reliability, while reducing instances of inter-UE sidelink interference.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or AI/ML, among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

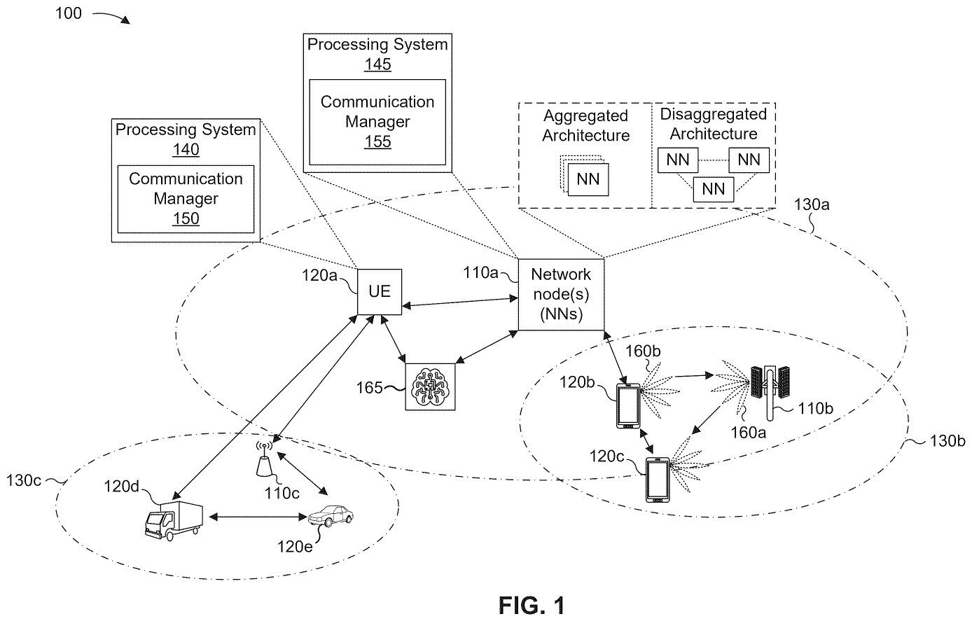

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, a UE 120d, and a UE 120e. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

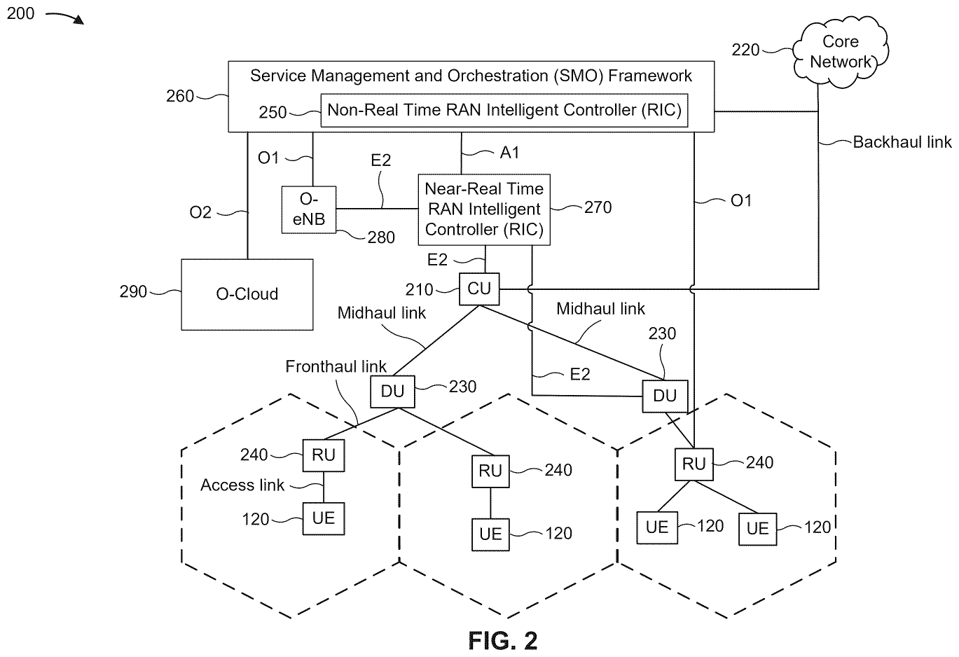

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell.

The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 may use to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some examples, two or more UEs 120 (for example, shown as UE 120a and UE 120d or the UE 120d and the UE 120e) may communicate directly with one another using sidelink communications (for example, without communicating by way of a network node 110 as an intermediary). As an example, the UE 120a may directly transmit data, control information, or other signaling as a sidelink communication to the UE 120d. This is in contrast to, for example, the UE 120a first transmitting data in an uplink communication to a network node 110c, which then transmits the data to the UE 120e in a downlink communication. In various examples, the UEs 120 may transmit and receive sidelink communications using peer-to-peer (P2P) communication protocols, D2D communication protocols, V2X communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. For example, the cell 130c may include a V2X network supported by the network node 110c. In some examples, the network node 110c may be a roadside unit or other device deployed in the V2X network. In some other deployments and configurations, a UE 120 (instead of a network node 110) may perform, or collaborate or negotiate with one or more other UEs to perform, scheduling operations, resource selection operations, and/or other operations for sidelink communications. Sidelink data and control transmissions (that is, transmissions directly between two or more UEs 120) may generally use similar techniques as were described for uplink data and control transmission, and may use sidelink-specific channels such as a PSSCH, a PSCCH, and/or a PSFCH.

In some aspects, a first UE 120 may include a communication manager 150. As described in more detail elsewhere herein, the communication manager 150 may obtain configuration information that includes a flexible parameter associated with selecting resources for sidelink communications, wherein the flexible parameter is associated with a plurality of parameter values; and transmit, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more KPIs associated with the sidelink environment. Additionally, or alternatively, the communication manager 150 may perform one or more other operations described herein.

In some aspects, a network node 110 may include a communication manager 155. As described in more detail elsewhere herein, the communication manager 155 may transmit, to a UE, configuration information that includes a flexible parameter associated with selecting resources for sidelink communications, wherein the flexible parameter is associated with a plurality of parameter values; and transmit, to the UE, a request to indicate one or more KPIs used by the UE to select a parameter value from the plurality of parameter values associated with the flexible parameter. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

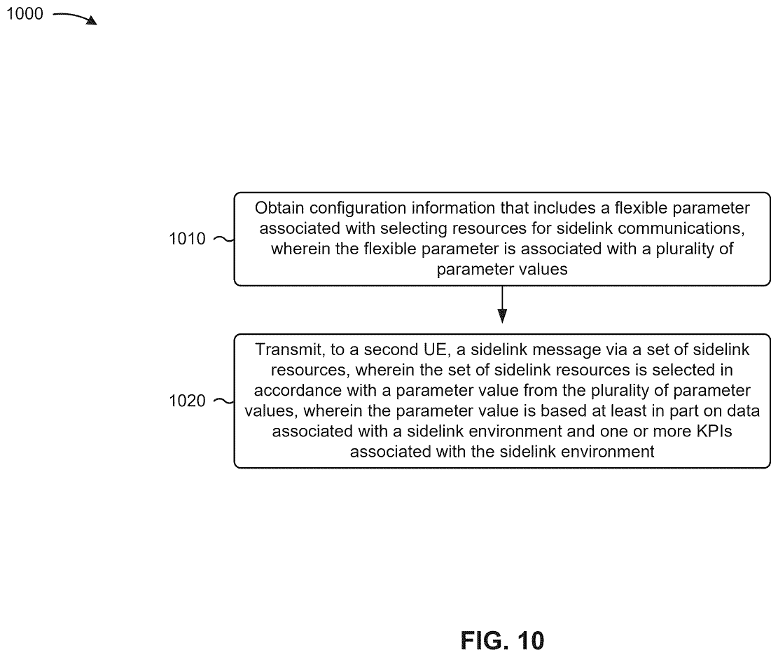

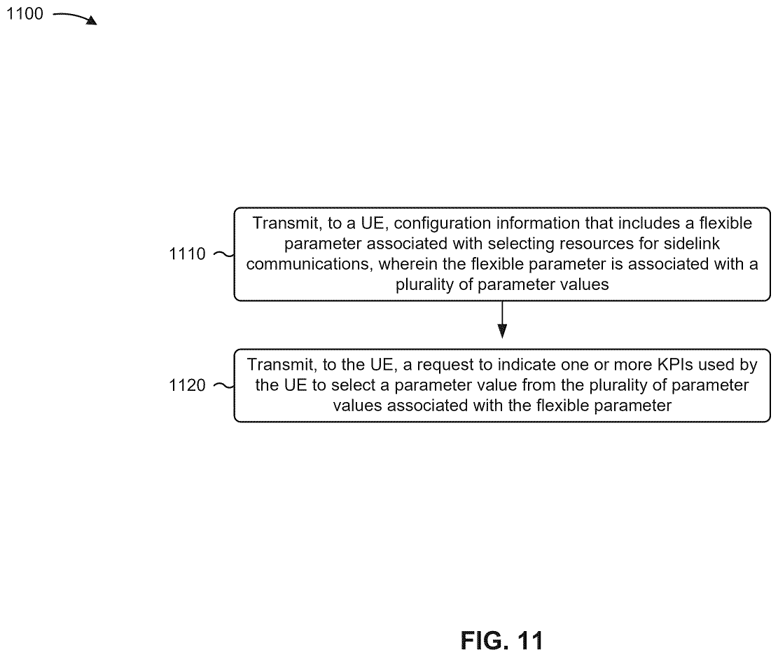

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with sidelink resource selection in accordance with a flexible parameter configuration, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

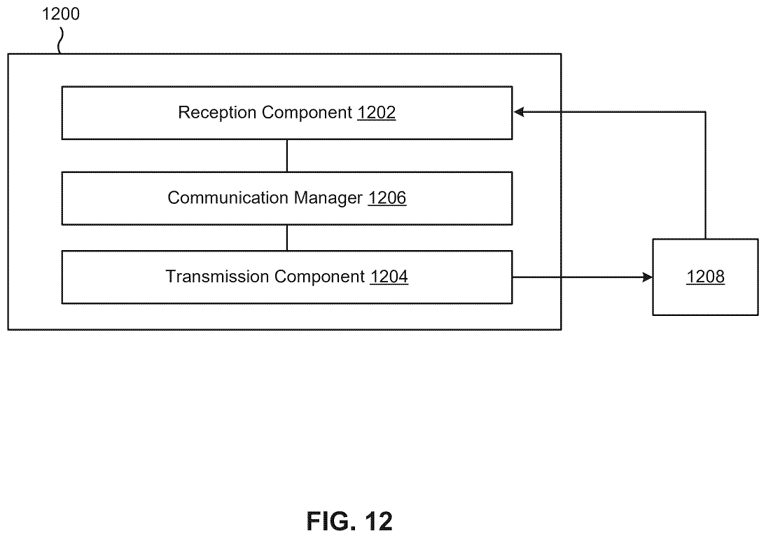

In some aspects, a first UE includes means for obtaining configuration information that includes a flexible parameter associated with selecting resources for sidelink communications, wherein the flexible parameter is associated with a plurality of parameter values; and/or means for transmitting, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more KPIs associated with the sidelink environment. The means for the first UE to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

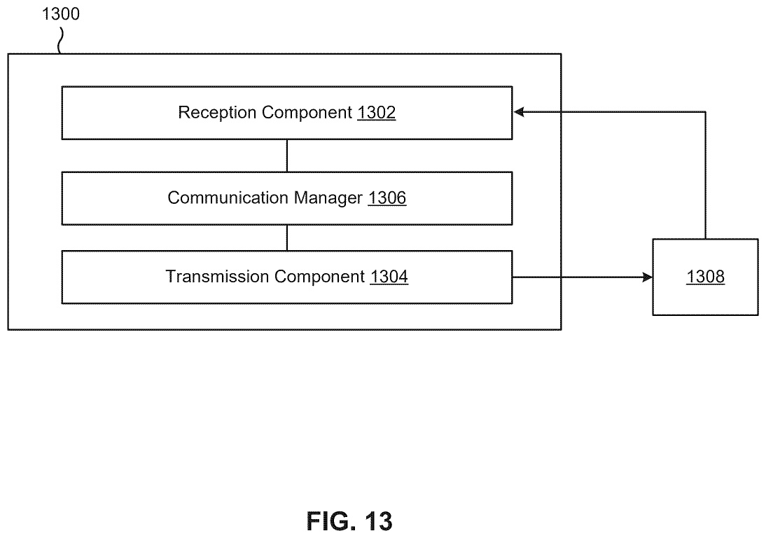

In some aspects, the network node includes means for transmitting, to a UE, configuration information that includes a flexible parameter associated with selecting resources for sidelink communications, wherein the flexible parameter is associated with a plurality of parameter values; and/or means for transmitting, to the UE, a request to indicate one or more KPIs used by the UE to select a parameter value from the plurality of parameter values associated with the flexible parameter. The means for the network node to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

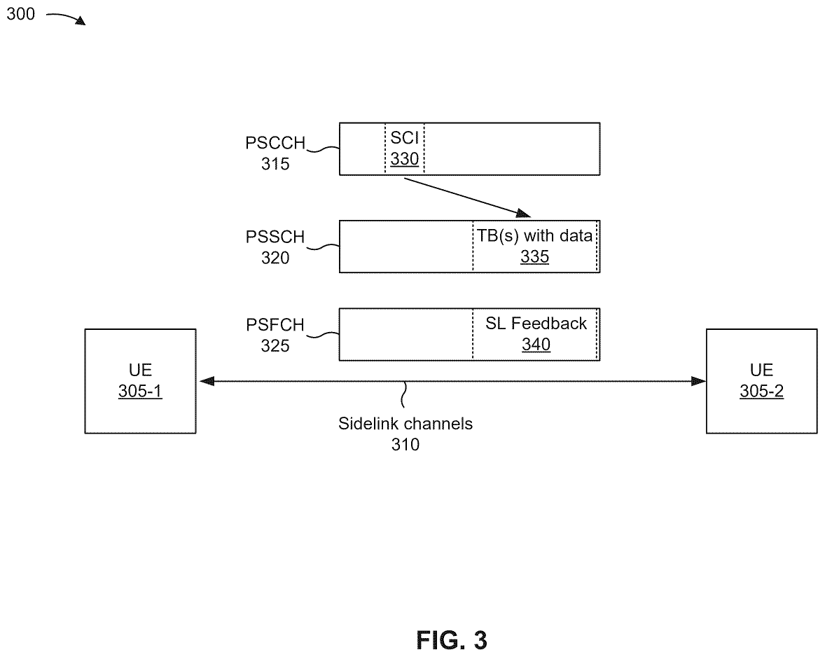

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a proximity-based communication 5 (PC5) interface and/or may operate in a high frequency band (e.g., the 5.9 GHz band). Additionally, or alternatively, the UEs 305 may synchronize timing of

transmission time intervals (TTIs) (e.g., frames, subframes, slots, or symbols) using GNSS timing.

As further shown in FIG. 3, the one or more sidelink channels 310 may include a PSCCH 315, a PSSCH 320, and/or a PSFCH 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as HARQ feedback (e.g., acknowledgement or negative acknowledgement (ACK/NACK) information), TPC, and/or a SR.

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, an NDI, a source identifier, a destination identifier, and/or a CSI report trigger.

In some aspects, the one or more sidelink channels 310 may use resource pools. For example, a scheduling assignment (e.g., included in SCI 330) may be transmitted in sub-channels using specific RBs across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in DCI or in a RRC message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a RSSI parameter (e.g., a sidelink-RSSI (S-RSSI) parameter) associated with various sidelink channels, may measure a RSRP parameter (e.g., a PSSCH-RSRP parameter) associated with various sidelink channels, and/or may measure a RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some examples, a UE 305 may obtain control information that includes one or more flexible parameters associated with selecting sidelink resources for sidelink communications. For example, a flexible parameter may be associated with multiple parameter values, where a UE 305 may select a parameter value from the multiple parameter values for use in selecting sidelink resources. In some examples, a UE 305 may select the parameter value in accordance with an inference model at the UE 305 (e.g., an AI/ML model). In some examples, a UE 305 may obtain the one or more flexible parameters via control signaling (e.g., RRC signaling) from the network node 110. In some examples, a UE 305 may obtain the one or more flexible parameters from memory at the UE 305 (e.g., the one or more flexible parameters are part of OEM configuration.

As indicated above, FIG. 3 is provided as an example. Other examples may differ from what is described with respect to FIG. 3.

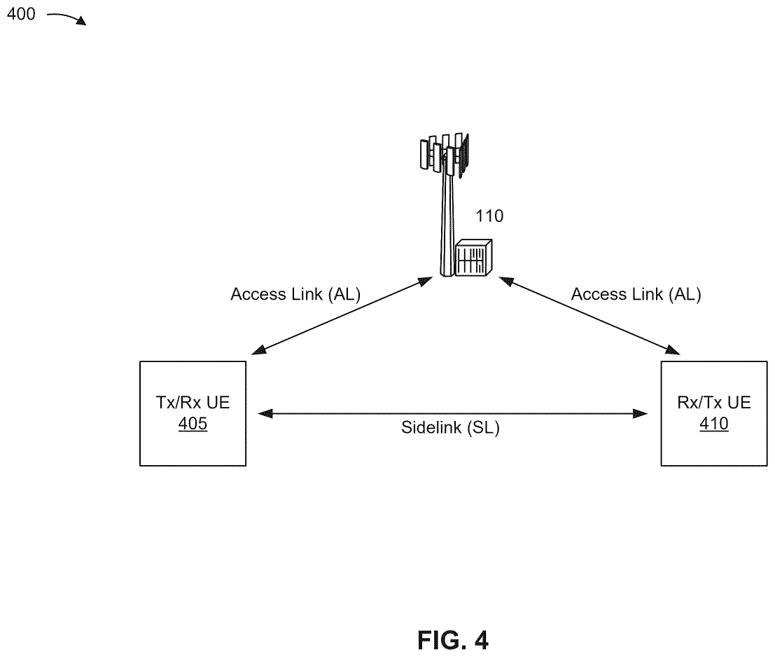

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some examples, the Tx/Rx UE 405 and/or the Rx/Tx UE 410 may obtain control information that includes one or more flexible parameters associated with

selecting sidelink resources for sidelink communications. For example, a flexible parameter may be associated with multiple parameter values, where the Tx/Rx UE 405 and/or the Rx/Tx UE 410 may select a parameter value from the multiple parameter values for use in selecting sidelink resources. In some examples, the Tx/Rx UE 405 and/or the Rx/Tx UE 410 may select the parameter value in accordance with an inference model at the Tx/Rx UE 405 and/or the Rx/Tx UE 410 (e.g., an AI/ML model). In some examples, the Tx/Rx UE 405 and/or the Rx/Tx UE 410 may obtain the one or more flexible parameters via control signaling (e.g., RRC signaling) from the network node 110. In some examples, the Tx/Rx UE 405 and/or the Rx/Tx UE 410 may obtain the one or more flexible parameters from memory at the Tx/Rx UE 405 and/or the Rx/Tx UE 410 (e.g., the one or more flexible parameters are part of OEM configuration.

As indicated above, FIG. 4 is provided as an example. Other examples may differ from what is described with respect to FIG. 4.

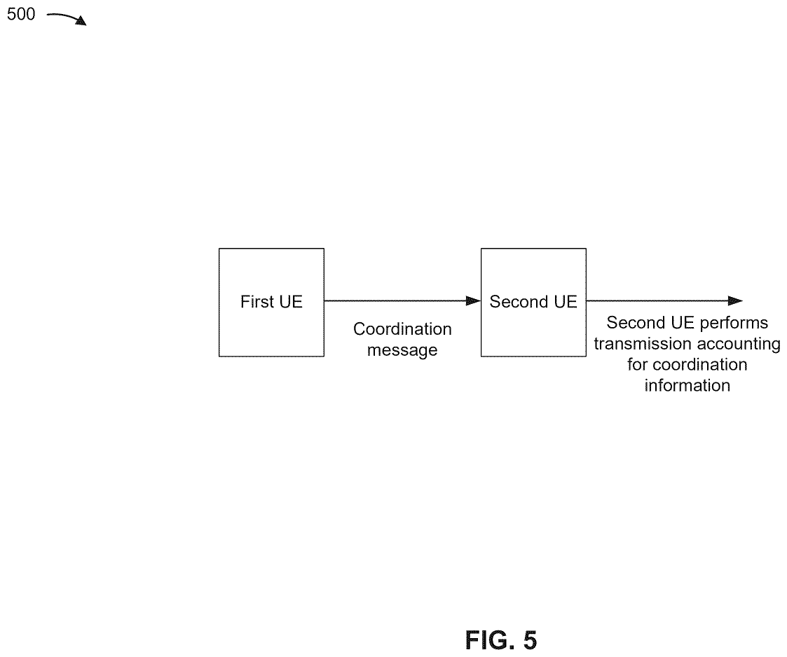

FIG. 5 is a diagram illustrating an example 500 of coordination signaling, in accordance with the present disclosure.

In example 500, a first UE (e.g., UE 120a of FIG. 1) exchanges inter-UE coordination signaling with a second UE (e.g., UE 120d of FIG. 1). The first UE and the second UE may operate in an in-coverage mode, a partial coverage mode, or an out-of-coverage mode with a network node 110. The first UE may determine a set of sidelink resources available for a resource allocation. The first UE may determine the set of sidelink resources based at least in part on determining that the set of sidelink resources are to be selected or based at least in part on a request, referred to herein as an inter-UE coordination request, received from the second UE or a network node 110. In some aspects, the first UE may determine the set of sidelink resources based at least in part on a sensing operation, which may be performed before receiving an inter-UE coordination request or after receiving the inter-UE coordination request.

The first UE may transmit an indication of the set of available resources to the second UE via inter-UE coordination signaling (shown as a coordination message, and referred to in some aspects as an inter-UE coordination message or inter-UE coordination information). In some aspects, the first UE may transmit the indication of the set of available resources while operating in NR sidelink resource allocation Mode 2. In NR sidelink resource allocation Mode 2, resource allocation may be handled by UEs (e.g., in comparison to NR sidelink resource allocation mode 1, in which resource allocation may be handled by a scheduling entity, such as a network node 110). In some aspects, the indication of the set of available resources may identify resources that are preferred by the first UE for transmissions by the second UE. Alternatively, the indication of the set of available resources may identify resources that are not preferred by the first UE for transmissions by the second UE (e.g., with the available resources being those other than the resources that are not preferred). Additionally, or alternatively, the inter-UE coordination signaling may indicate a resource conflict (e.g., a collision), such as when two UEs have reserved the same resource (e.g., and were unable to detect this conflict because the two UEs transmitted a resource reservation message on the same resource and thus did not receive one another's resource reservation messages due to a half-duplex constraint).

The second UE may select a sidelink resource for a transmission from the second UE based at least in part on the set of available resources indicated by the first UE. As shown, the second UE may account for the coordination information when transmitting (e.g., via a sidelink resource indicated as available by the inter-UE coordination message). Inter-UE coordination signaling related to resource allocation may reduce collisions between the first UE and the second UE and may reduce a power consumption for the first UE and/or the second UE (e.g., due to fewer retransmissions as a result of fewer collisions).

In some examples, the first UE may use one or more flexible parameters in accordance with determining the set of sidelink resources during the sensing operation. In some examples, the first UE may obtain control information that includes the one or more flexible parameters associated with selecting sidelink resources for sidelink communications. For example, a flexible parameter may be associated with multiple parameter values, where the first UE may select a parameter value from the multiple parameter values for use in selecting sidelink resources. In some examples, the first UE may select the parameter value in accordance with an inference model at the first UE (e.g., an AI/ML model). In some examples, the first UE may obtain the one or more flexible parameters via control signaling (e.g., RRC signaling) from the network node 110. In some examples, the first UE may obtain the one or more flexible parameters from memory at the first UE (e.g., the one or more flexible parameters are part of OEM configuration.

Although FIG. 5 shows a single first UE transmitting inter-UE coordination information to a single second UE, in some aspects, a single first UE may transmit inter-UE coordination information to multiple UEs to assist those UEs with selecting resources for transmissions. Additionally, or alternatively, the second UE may receive inter-UE coordination information from multiple UEs, and may use that information to select resources for a transmission (e.g., resources that avoid a conflict with all of the multiple UEs or as many as possible).

As indicated above, FIG. 5 is provided as an example. Other examples may differ from what is described with respect to FIG. 5.

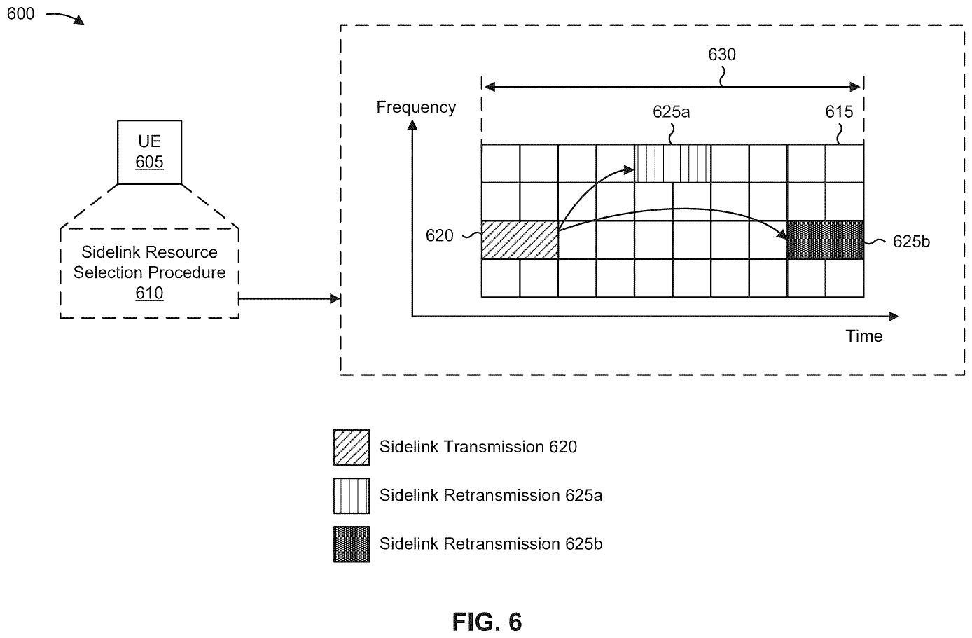

FIG. 6 is a diagram illustrating an example 600 of sidelink resource selection, in accordance with the present disclosure. In some instances, example 600 may implement or be implemented by one or more aspects of FIGS. 1 through 5. For example, the UE 605 may correspond to one or more other UEs 605 described elsewhere herein, such as UE 120, UE 305-1, UE 305-2, Tx/Rx UE 405, or Rx/Tx UE 410.

As shown in FIG. 6, the UE 605 may perform a sidelink resource selection procedure 610. In some examples, the sidelink resource selection procedure 610 may be associated with sidelink resource selections, where the UE 605 may autonomously reserve resources. For instance, as described elsewhere herein, the UE 605 may operate using a transmission mode (e.g., Mode 2) where resource selection and/or scheduling may be performed by the UE 605 (e.g., rather than a network node 110).

In some examples, the UE 605 may perform the sidelink resource selection procedure 610 to select a set of candidate resources (e.g., from a set of sidelink resources 615) to transmit a sidelink transmission 620 to another UE 605. In some examples, the sidelink transmission 620 may be associated with a priority level (e.g., prioⱼ where the value j is an integer number associated with the priority level). In accordance with upper layer parameters and/or a processing timeline configured for the UE 605, the UE 605 may determine a sidelink sensing window and a sidelink selection window 630. In some examples, the sidelink resource selection procedure 610 may be performed at a PHY layer of the UE 605.

In a first operation of the sidelink resource selection procedure 610, the UE 605 may determine all sidelink resources 615 (e.g., L_{subch} wide in frequency) within the sidelink selection window 630. For example, as illustrated, sidelink selection window 630 may include the set of sidelink resources 615 that span a frequency domain (e.g., including a set of RBs, a set of subcarriers, a set of carriers, a set of BWPs, a set of frequency bands, or a set of channels) and a time domain (e.g., including a set of frames, a set of subframes, a set of slots, or a set of symbols). In example 600, the sidelink resources 615 may each be slot sidelink resources; however, in other examples, the sidelink resources 615 may span other durations of time, as described herein. Additionally, in example 600, the set of sidelink resources 615 span L_{subch}, where L may be an integer number of subchannels.

In a second operation of the sidelink resource selection procedure 610, the UE 605 may perform resource exclusion based on SCI decoded during the sensing window. For instance, the SCI may be an example of SCI 330 (with reference to FIG. 3) and/or inter-UE 605 coordination signaling (with reference to FIG. 5). That is, the UE 605 may receive respective SCI from one or more other UEs 605, where each respective SCI indicates one or more first sidelink resources 615 during the sidelink selection window 630 that are available for sidelink resource allocation Mode 2 and/or one or more second sidelink resources 615 during the sidelink selection window 630 that are not available for sidelink resource allocation Mode 2. Therefore, the UE 605 may exclude the one or more first sidelink resources 615 from the pool of candidate resources to use for the sidelink transmission 620. In some examples, the sensing window may be a duration during which the UE 605 monitors for SCI from other UEs 605.

In a third operation of the sidelink resource selection procedure 610, the UE 605 may determine one or more quality thresholds associated with excluding additional sidelink resources 615 from the pool of candidate resources. For example, the one or more quality thresholds may be associated with one or more respective sidelink priorities (e.g., a first quality threshold associated with prioᵢ, a second quality threshold associated with prioⱼ, etc.). In example 600, the one or more quality thresholds may be RSRP thresholds; however, in some other examples, the one or more quality thresholds may be associated with a different quality metric (e.g., including one or more of RSSI or RSRQ). In some examples, the UE 605 may determine the one or more quality thresholds based on a network node 110 transmitting, and the UE 605 receiving, upper layer signaling (e.g., RRC signaling) that indicates the one or more quality thresholds.

In a fourth operation of the sidelink resource selection procedure 610, the UE 605 may define a sidelink allocation set from the set of sidelink resources 615 included in the sidelink selection window 630. For example, the number of sidelink resources associated with the sidelink allocation set may be an integer number M.

In a fifth operation of the sidelink resource selection procedure 610, the UE 605 may exclude sidelink resources 615 from the pool of candidate resources, if the sidelink resources 615 are during a time period during which the UE 605 was unable to sense the sidelink channel. For instance, if during slot T the UE 605 was unable to sense the sidelink channel associated with sidelink selection window 630, then the UE 605 may exclude single slot sidelink resources 615 that occur during slot T+Tₚₑᵣ from the pool of candidate resources (where Tₚₑᵣ may be a set of slot periodicities).

In a sixth operation of the sidelink resource selection procedure 610, the UE 605 may exclude sidelink resources from the pool of candidate resources if the sidelink resources 615 have been indicated as reserved by an SCI decoded at the UE 605 (e.g., SCI received by the UE 605 during the sensing window) and if the decoded SCI is associated with a quality metric that satisfies the quality threshold (e.g., the RSRP of the SCI is greater than the RSRP threshold associated with prioᵢ, if the SCI is scheduling one or more sidelink transmissions associated with prioᵢ).

In a seventh operation of the sidelink resource selection procedure 610, the UE 605 may determine a number of sidelink resources 615 that remain in the pool of candidate resources (e.g., based on performing the fourth through sixth operations of the sidelink resource selection procedure 610). If at least X*M sidelink resources 615 are not available in the pool of candidate resources (e.g., where X may be an integer number), then the UE 605 may update the quality threshold by a step size and repeat the fourth through seventh operations. For instance, the UE 605 may increase a value of the RSRP threshold associated with prioᵢ by a configured RSRP step size (such as 3 dB), and repeat the fourth through seventh operations of the sidelink resource selection procedure 610. If the UE 605 determines to repeat the fourth through seventh operations of the sidelink resource selection procedure 610, the UE 605 may add back in all sidelink resources 615 excluded during the previous iteration of the fourth through seventh operations.

After the pool of candidate resources includes at least X*M sidelink resources 615, the PHY layer may indicate the pool of candidate resources to a MAC layer of the UE 605. In some examples, the PHY layer may additionally indicate to the MAC layer one or more sidelink resources 615 for re-evaluation of the MAC layer and one or more sidelink resources 615 that are pre-empted based on another UE 605 associated with a higher sidelink priority compared to the UE 605.

By performing the one or more operations of the sidelink resource selection procedure 610, the UE 605 may select one or more sidelink resources 615 included in the pool of candidate resources to transmit the sidelink transmission 620 (as shown in FIG. 6). In some examples, the UE 605 may additionally select one or more sidelink resources included in the pool of candidate resources for potential sidelink retransmissions 625. For example, if the UE 605 transmits the sidelink transmission 620 to a second UE 605, and the UE 605 receives from the second UE 605 a NACK associated with the sidelink transmission, then the UE 605 may transmit a sidelink retransmission 625 which includes the information included in sidelink transmission 620. In some examples, the UE 605 may reserve resources for up to two sidelink retransmissions 625 (e.g., sidelink retransmission 625a and 625b, in example 600). In some examples, the UE 605 may randomly select N sidelink resources 615 from the pool of candidate resources for the sidelink transmission 620 and/or the sidelink retransmissions 625.

As described herein, the UE 605 may perform the sidelink resource selection procedure 610 at the PHY layer in accordance with one or more parameters configured by the network node. For example, the network node may transmit, and the UE 605 may receive, RRC signaling (such as an RRC connection setup message and/or an RRC connection reconfiguration message) that indicates one or more parameters associated with sidelink Mode 2 resource selection. The one or more parameters may indicate the one or more quality thresholds as described with respect to the third and sixth operations of the sidelink resource selection procedure 610 (e.g., via sl-Thres-RSRP-List-r16). For example, sl-Thres-RSRP-List-r16 indicates a threshold for each pair of traffic priority used for sensing-based UE 605 autonomous resource selection. The UE 605 may exclude the resource if the resource is indicated or reserved by a decoded SCI, and PSSCH/PSCCH RSRP in the associated data resource is above the threshold. The one or more parameters may indicate the sensing window (e.g., via sl-SensingWindow-r16, which may indicate the start of the sensing window). The one or more parameters may indicate a portion of single-slot PSSCH resources over the total sidelink resources 615 of the sidelink selection window 630 (e.g., via sl-TxPercentageList-r16). For instance, if the value of sl-TxPercentageList-r16 is a value of p20, then for each priority level, 20% of the total sidelink resources 615 are candidate resources. The one or more parameters may indicate whether preemption is enabled or disabled in accordance with the sidelink resource selection procedure 610 (e.g., via sl-PreemptionEnable).

Additionally, the one or more parameters indicated via the RRC signaling may be associated with sidelink resource protection and/or HARQ retransmissions in SCI. The one or more parameters may enable the UE 605 to reserve one or more of the sidelink resources 615 (e.g., via sl-MultiReserveResource-r16). For example, if the sl-MultiReserveResource-r16 is enabled, then the UE 605 may transmit an indication, as part of an SCI, that indicates resources for a retransmission of a transport block after a configured time (e.g., P-rsvp). The one or more parameters may indicate to the UE 605 one or more resource reservation periods (e.g., indicate one or more values for P-rsvp via sl-ResourceReservePeriodList-r16). The one or more parameters may indicate to the UE 605 a permissible (maximum) number of reserved sidelink resources that can be indicated by an SCI (e.g., via sl-MaxNumPerReserve-r16, which may be set to a value of 2 or of 3). The one or more parameters may indicate a communication range for distance-based sidelink groupcast (e.g., via sl-TransRange-r16). For example, an Rx UE 605 may transmit a NACK feedback to a Tx UE 605, if the Rx UE 605 determines that the Tx UE 605 is within the communication range indicated by the sl-TransRange-r16 and if decoding of the PSSCH from the Tx UE 605 fails.

While the one or more parameters described herein may be indicated via RRC signaling, in some examples one or more of the one or more parameters may be preconfigured at the UE 605 by an operator (e.g., as part of an OEM configuration). Additionally, the one or more parameters may be updated through RRC signaling (e.g., RRC connection reconfiguration) or through firmware updates.

In some examples, under different channel and/or traffic conditions, different configurations of the one or more parameters may result in increased performance at the UE 605.

In a first example, the permissible communication range that is supported for sidelink message reliability to satisfy a threshold may be different between different environmental settings of the UE 605. For instance, in an urban setting the permissible communication range that is supported to satisfy a packet reliability of 95% may be 80 meters (m), while in a highway setting, the permissible communication range that is supported to satisfy a packet reliability of 95% may be 240 m.

In a second example, the UE 605 may benefit from different values for the one or more quality thresholds (e.g., RSRP thresholds configured for a pair of priority values) based on different environmental settings of the UE 605. For instance, setting the RSRP threshold to a relatively high value (e.g., −75 dBm) may reduce time at the UE 605 in selecting sidelink resources 615 for the sidelink transmission 620. However, as communication range increases and/or as the number of sidelink UEs 605 in a sidelink network increases, a relatively high RSRP threshold may result in an increased number of sidelink packet collisions. Conversely, setting the RSRP threshold to a relatively low value (e.g., −98 dBm) may reduce the occurrence of sidelink collisions because the UE 605 has a higher likelihood of selecting candidate resources that are not in contention by other UEs 605 of the sidelink network. However, as the RSRP threshold decreases, a time associated with selecting candidate resources, which may increase latency. Additionally, as latency increases, selected candidate resources may result in preemption or incur collisions (e.g., due to the information used by the UE 605 for selecting the candidate resource becoming out of date or “stale”).

Other parameters of the one or more parameters used in accordance with the sidelink resource selection procedure 610 may be associated with similar trade-offs depending on the environment associated with the sidelink network. In some cases, however, predicting respective values for the one or more parameters that balance trade-offs and suit the sidelink network may be associated with intensive system simulations. Additionally, such system simulations may also be limited in scope by underlying assumptions that may not be replicated in a real-world deployment of a sidelink network. Additionally, the decentralized nature of a sidelink system and/or changes to the sidelink system associated with mobility of multiple UEs 605 may increase complexity of a network node individually configuring each UE 605 of the sidelink network with up-to-date parameters for use in the Mode 2 sidelink resource selection.

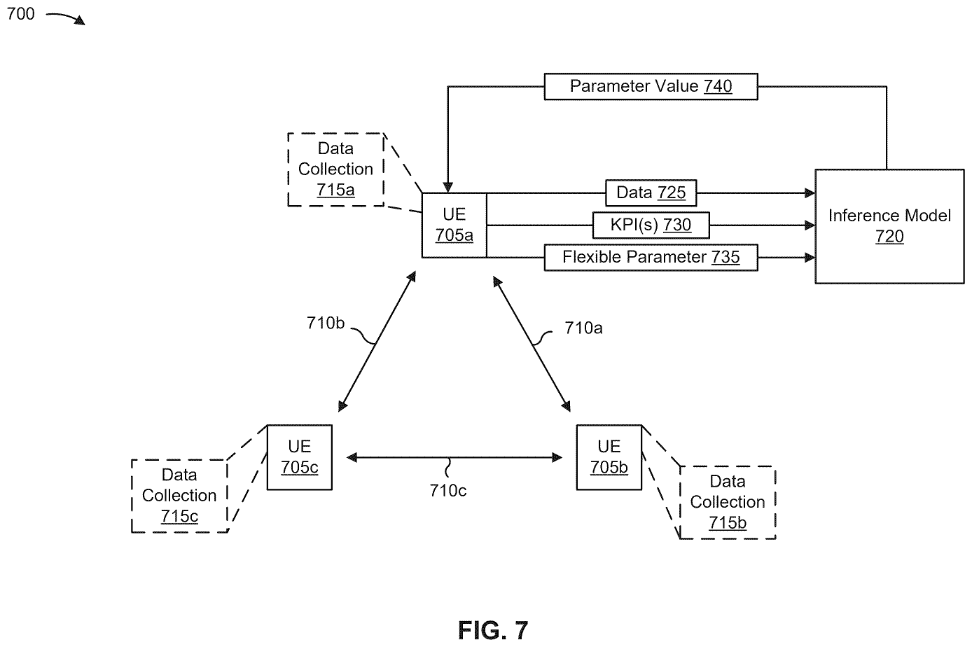

FIG. 7 is a diagram illustrating an example 700 associated with sidelink resource selection associated with a flexible parameter configuration, in accordance with the present disclosure. In some instances, example 700 may implement or be implemented by one or more aspects of FIGS. 1 through 6. For example, the UE 705a, 705b, and 705c may respectively correspond to one or more other UEs described elsewhere herein, such as UE 120, UE 305-1, UE 305-2, Tx/Rx UE 405, Rx/Tx UE 410, or UE 605.

As shown in FIG. 7, the UEs 705 may communicate via one or more sidelinks 710. For example, the UE 705a and the UE 705b may communicate via a sidelink 710a, the UE 705a and the UE 705c may communicate via a sidelink 710b, and the UE 705a and the UE 705c may communicate via a sidelink 710c. In some examples, the UEs 705 may communicate one or more sidelink messages via the sidelinks 710. For instance, example 700 may correspond to a distributed sidelink communication system, where the UEs 705 transmit and receive sidelink messages (e.g., SCI transmitted on PSCCH, data transmissions on PSSCH, and/or feedback information on PSFCH). In some examples, the UEs 705 communicate directly without routing messages through a centralized network node (such as via sidelink unicast and/or sidelink groupcast). Therefore, the UEs 705 may dynamically manage resources and ensure proper synchronization to avoid message collisions. The sidelink messages may include one or more of basic safety messages (BSMs), coordinated driving messages, or sensor sharing messages, among other examples. BSMs may be applied in V2X communication for collision warnings, lane changes, and hazard notifications. In some examples, BSM transmissions may be periodic and associated with a latency below a threshold (e.g., low-latency) to enable timely responses. Coordinated driving messages may facilitate vehicle platooning and automated maneuvers of the UEs 705 (such as merging or overtaking). In some examples, the coordinated driving messages may be associated with a reliability metric above a threshold (e.g., high reliability) to enable safety and/or coordination among vehicles and/or pedestrians. Sensor sharing messages may indicate real-time data (e.g., light detection and ranging (LiDAR), radar, camera feeds, among other examples) to enhance situational awareness.

To enable transmission and reception of the sidelink messages between the UEs 705, each of the UEs 705 may perform sidelink Mode 2 resource selection, as described elsewhere herein (such as in accordance with one or more aspects of the sidelink resource selection procedure 610). That is, the UEs 705 may use one or more parameters that are configured via RRC signaling and/or an OEM configuration to select sidelink resources while reducing collision of sidelink messages within the distributed sidelink communication system.

In accordance with the techniques described herein, a network node and/or an operator may provide the UEs 705 with a set of flexible parameters 735 associated with selecting resources for sidelink communications in a Mode 2 sidelink resource selection. For example, each flexible parameter 735 may be associated with a set or range of parameter values that each UE 705 may select from for use in Mode 2 sidelink resource selection.

In some examples, a UE 705 may select a parameter value 740 for a flexible parameter 735 in accordance with an inference model 720. For instance, as shown in FIG. 7, the UE 705a may input, into the inference model 720, data 725, one or more KPIs 730, and the flexible parameter 735. Additionally, the inference model 720 may output the parameter value 740. In other words, the inference model 720 uses the data 725 and the one or more KPIs 730 to select a parameter value 740 from the set or range of parameter values associated with the flexible parameter 735. Therefore, the UE 705a may input one or more flexible parameters 735 into the inference model 720 such that the inference model 720 may output one or more parameter values 740 respectively associated with the one or more flexible parameters 735. In some examples, the one or more flexible parameters 735 may be associated with one or more of the parameters described with reference to example 600.

The one or more flexible parameters 735 may include parameter sl-Thres-RSRP-List-r16. For example, parameter sl-Thres-RSRP-List-r16 may indicate a variable threshold for each traffic priority level used for sensing-based autonomous resource selection. Each quality threshold range may represent a range from which the UE 705a selects a quality threshold in accordance with the inference model 720. In some examples, the UE 705a may use the selected quality threshold in accordance with performing the third operation of sidelink resource selection procedure 610. That is, the selected quality threshold may be an RSRP threshold used by the UE 705a for exclusion of sidelink resources from the set of candidate resources.

The one or more flexible parameters 735 may include parameter sl-SensingWindow-r16. For example, the parameter sl-SensingWindow-r16 may indicate a range of sensing window durations for each priority level associated with the UE 705a. In some examples, the UE 705a selects a sensing window from the range of sensing window durations in accordance with the inference model 720. In some examples, the UE 705a may use the selected sensing window in accordance with performing the second operation of sidelink resource selection procedure 610.

The one or more flexible parameters 735 may include parameter sl-TxPercentage-r16. For example, the parameter sl-TxPercentage-r16 may indicate a range for the value of X as described with reference to the seventh operation of the sidelink resource selection procedure 610. In some examples, the UE 705a selects the value of X from the range of the values of X in accordance with the inference model 720.

The one or more flexible parameters 735 may include parameter sl-adaptableStepSize. For example, the parameter sl-adaptableStepSize may configure a list or set of step sizes associated with increasing the value of the quality threshold in accordance with performing the seventh operation of sidelink resource selection procedure 610 (e.g., an RSRP step size). In some examples, the UE 705a may select a step size from the list or set of step sizes in accordance with the inference model 720.

The one or more flexible parameters 735 may include parameter sl-ResourceReservePeriodList-r16. For example, the parameter sl-ResourceReservePeriodList-r16 may indicate a set of resource reservation periods (e.g., indicate one or more values for P-rsvp). In some examples, the UE 705a may select a resource reservation period from the set of resource reservation periods in accordance with the inference model 720.

The one or more flexible parameters 735 may include parameter sl-ResourceReservePeriodSkip-AI. For example, the parameter sl-ResourceReservePeriodSkip-AI may indicate a set of possible values of a parameter N_skip. For example, N_skip may be an integer number of periods, where after N_skip periods, the UE 705a may disregard a periodic reservation of sidelink resources reserved by another UE 705 in the distributed sidelink communication system. In some examples, the UE 705a may select a value for parameter N-skip from the set of possible values of the parameter N_skip in accordance with the inference model 720.

The one or more flexible parameters 735 may include parameter sl-MaxNumPerReserve-r16. For example, the parameter sl-MaxNumPerReserve-r16 may indicate a range of permissible (maximum) numbers of reserved PSCCH/PSSCH resources that can be indicated by an SCI. In some examples, the UE 705a may select a number from the range of permissible numbers in accordance with the inference model 720.

The one or more flexible parameters 735 may include parameter sl-TransRange-r16. For example, the parameter sl-TransRange-r16 may include a list or set of communication ranges, where if the UE 705a is within a given communication range of another UE 705, then the UE 705a is enabled to communicate sidelink traffic with the other UE 705. In some examples, the UE 705a may select a communication range from the list or set of communication ranges in accordance with the inference model 720.

The one or more flexible parameters 735 may include parameter sl-TransRangeHystAI-r16. For example, the parameter sl-TransRangeHystAI-r16 may be a range of distances (e.g., [r1, r2] meters) that may be added to the communication range selected in accordance with parameter sl-TransRange-r16. That is, the parameter sl-TransRangeHystAI-r16 may be associated with extending the selected communication range. In some examples, the UE 705a may select a distance from the range of distances in accordance with the inference model 720 (e.g., based on input from the inference model 720).

In some examples, the one or more flexible parameters 735 may be associated with enabling and/or disabling one or more operations of the inference model 720. For example, the one or more flexible parameters 735 may include parameter sl-step5periodictyDisable. For example, parameter sl-step5periodictyDisable may indicate whether to enable or disable the exclusion of traffic periodicities associated with slot T+Tₚₑᵣ in accordance with the fifth operation of the sidelink resource selection procedure 610. If the parameter sl-step5periodictyDisable disables the exclusion of all traffic periodicities, then the UE 705a may be enabled to operate in accordance with the inference model 720 to determine the relevant periodicities to exclude in accordance with the fifth operation of the sidelink resource selection procedure 610.

The one or more flexible parameters 735 may include parameter sl-PreemptionEnable. For example, the parameter sl-PreemptionEnable indicates whether preemption may be enabled in a sidelink resource pool. If a field associated with preemption is indicated to the UE 705a (e.g., p_preemption is set to a value of pl1, pl2, etc.), but the parameter sl-PreemptionEnable is not enabled, then the preemption may be enabled and a priority level of p_preemption is configured. If, however, the field is present and the value is enabled, the preemption may be enabled (but p_preemption is not configured) and preemption is applicable to all priority levels.

The one or more flexible parameters 735 may include parameter sl-AiRscSelection. For example, if the parameter sl-AiRscSelection is enabled (e.g., toggled), then the MAC layer associated with the UE 705a may operate in accordance with the inference model 720 to select sidelink resources for a sidelink transmission (e.g., rather than randomly selecting N sidelink resources 615 from the pool of candidate resources, as described with reference to example 600).

The one or more flexible parameters 735 may include parameter sl-enableAIMLRscSel. For example, if the parameter sl-enableAIMLRscSel is enabled, then the UE 705a may operate in accordance with the inference model 720 for sidelink resource selection. In other words, the parameter sl-enableAIMLRscSel may enable the UE 705a to perform one or more operations of the sidelink resource selection procedure 610 in accordance with the inference model 720.

The one or more flexible parameters 735 may include parameter sl-MultiReserveResource-r16. For example, the parameter sl-MultiReserveResource-r16 may indicate whether the UE 705a is enabled to reserve a sidelink resource for an initial transmission of a transport block by an SCI associated with a different transport, based on sensing and the resource selection procedure.

The one or more flexible parameters 735 may include parameter sl-MultiReserveResourceAI. For example, the parameter sl-MultiReserveResourceAI may indicate whether the parameter sl-MultiReserveResource-r16 is enabled based on the inference model 720.

As described herein, the inference model 720 may select one or more parameter values 740 based on the data 725. In some examples, the data 725 may be included and/or be associated with data collected by the UE 705a as part of a data collection 715a. As part of data collection 715a, the UE 705a may collect data from one or more co-located sensors associated with the UE 705a. For example, the UE 705a may be associated with one or more scene information sensors (e.g., cameras, LiDAR sensors, radar sensors, and/or ultrasonic sensors), one or more road and/or weather condition sensors (e.g., infrared cameras, rain sensors, tire pressure monitors, and/or temperature sensors), one or more vulnerable road user (VRU) sensors (e.g., infrared sensors, pedestrian detection cameras, and/or micro-Doppler radar), one or more dynamic motion sensors (e.g., accelerometers, gyroscopes, an inertial measurement unit (IMU), braking sensors, and/or steering angle sensors), and/or one or more other sensors (e.g., air quality sensors, a global positioning system (GPS), microphones, and/or battery management sensors).

In some examples, the UE 705a may use the one or more co-located sensors to collect scene information. In some examples, the UE 705a may use the scene information to deduce and/or predict a potential environment setting of the UE 705a (e.g., urban, rural, highway, etc.), an expected link quality associated with sidelink 710a and/or 710b (e.g., non-line-of-sight (NLoS), line-of-sight (LoS), and/or blockage), presence of other potential sidelink UEs 705 (e.g., high vehicle traffic during office hours, low traffic at night-time, congestion due to special events).

In some examples, the UE 705a may use the one or more co-located sensors to collect information about road and weather conditions. For example, the road and weather conditions may include one or more of detected work zones, accidents, or inclement weather conditions (e.g., rain, fog, snow, slippery road, or signs by police personnel), among other examples.

In some examples, the UE 705a may use the one or more co-located sensors to collect information associated with the detection of vulnerable road users, risky drivers, and other unpredictable behaviors.

In some examples, the UE 705a may use the one or more co-located sensors to collect information associated with a dynamic motion of the UE 705a, such as velocity, acceleration, and/or braking. Additionally, if the UE 705a is located in a vehicle, then the UE 705a may use such information to determine the behavior of a driver of the vehicle or one or more other drivers associated with the dynamic sidelink communication environment.

In some examples, the data collection 715a may include data associated with previous or current channel monitoring performed by the UE 705a. For example, the UE 705a may measure the channel quality of one or more sidelink channels associated with the sidelinks 710 (e.g., signal-to-noise ratio (SNR), signal-to-interference-plus-noise ratio (SINR), RSRP, RSRQ, CQI, packet error rate (PER), RSSI, and/or pathloss). Data collected in accordance with channel monitoring may be included in the data 725. In some examples, the data collection 715a may include data associated with previous transmission statistics of the UE. For example, the previous transmission statistics may include one or more of a number of packets transmitted by the UE 705a, a number of packets received by the UE 705a, a packet success rate (PSR), a retransmission count, an average transmission latency, one or more transmission power levels, a resource utilization rate, a resource collision count, a channel occupancy ratio, an average data rate, a resource reservation success rate, and/or a number of HARQ retransmissions. Data collected in accordance with previous transmission statistics may be included in the data 725.

As described herein, inference model 720 may use the data 725 collected as part of the data collection 715a to select one or more parameter values 740 respectively associated with one or more flexible parameters 735. In a first example, the inference model 720 may select/update the communication range (e.g., associated with parameter sl-TransRange-r16 and/or parameter sl-TransRangeHystAI-r16) in accordance with the potential environment setting of the UE. In a second example, the inference model 720 may select and/or update the quality threshold and/or a step size of the quality threshold (e.g., associated with parameter sl-Thres-RSRP-List-r16 and/or parameter sl-adaptableStepSize) in accordance with expected link qualities and/or road/weather conditions. Therefore, the inference model 720 may select and/or update multiple parameter values 740 in accordance with the data collected from the co-located sensors. Such applications of the inference model 720 may enable the UE 705a to select sidelink resources using the one or more parameter values 740 that consider the dynamic sidelink communication environment in real time.

In some examples, the data 725 may include and/or be associated with data that the UE 705a receives from other UEs 705. For example, the UE 705a may receive sidelink messages from the UE 705b and the UE 705c that indicate data that the UE 705a includes in the data 725. In some examples, the data received from other UEs 705 may include data collected during respective data collections 715. For example, as shown in FIG. 7, the UE 705b may perform a data collection 715b and the UE 705c may perform 715c. In some examples, the data received from other UEs 705 may include statistics collocated by the other UEs 705 associated with local resource selection procedures. For example, the UE 705b may transmit, and the UE 705a may receive, information associated with parameter values 740 in use at the UE 705b. For example, such information may include an RSRP threshold at which the resource exclusion process at the UE 705b converges for a given priority level. Additionally, or alternatively, such information may include the value of X selected by the UE 705b for the seventh operation of the sidelink resource selection procedure 610 for each priority level. Additionally, or alternatively, such information may include a duration of the sensing window and/or the sidelink selection window selected by the UE 705b for one or more traffic types. In other words, such information that the UE 705a receives from other UEs 705 may be associated with any of the flexible parameters 735 in use by the other UEs 705.

In some examples, the UE 705a may receive, from the other UEs 705, indications of collision probabilities for one or more sidelink resources. For instance, the UE 705a may receive, from the UE 705b, collision probability information that indicates one or more sidelink resources that are respectively associated with one or more collision probabilities that satisfy a threshold (e.g., high probability of collision). Additionally, or alternatively, the collision probability information may indicate one or more periodic sidelink resources associated with a number of collisions that satisfies a threshold. Therefore, the data 725 may include data collected by the UE 705a and/or data collected by other UEs 705 associated with the dynamic sidelink communication environment.

As described herein, the inference model 720 may select one or more parameter values 740 based on the one or more KPIs 730. For example, the inference model 720 may account for the one or more KPIs 730 to ensure that sidelink resource selection considers one or more preferences of the UE 705a for performing sidelink transmissions.

In some examples, the UE 705a may prioritize a KPI 730 associated with avoiding resources with frequent preemption. As described herein, preemption occurs if the UE 705a unsuccessfully allocates a sidelink resource due to contention or higher-priority transmissions. To mitigate preemption, the UE 705a may prioritize one or more KPIs 730 associated with resource retention rate, interference metrics, and/or neighboring device activity. A KPI 730 associated with resource retention rate may prioritize a percentage of time that the UE 705a successfully retains a selected resource without being preempted. A KPI 730 associated with interference metrics may prioritize sidelink resources associated with an interference metric below a threshold (such as a low SINR or a low RSSI). A KPI 730 associated with neighboring device activity may prioritize avoiding sidelink resources associated with contention from other UEs 705.

In some examples, the UE 705a may prioritize a KPI 730 associated with avoiding aggressive channel access and/or channel load. In other words, the UE 705a may prevent overloading a sidelink channel by considering KPIs 730 that prioritize efficiency in resource usage. For example, a KPI 730 may prioritize a channel occupancy rate to enable the UE 705a to select sidelink resources associated with a rate of collision below a threshold. A KPI 730 may prioritize reducing channel access attempts. A KPI 730 may prioritize transmission load balance by evaluating the distribution of sidelink resource usage across a sidelink channel and/or encourage selection of underutilized sidelink resources to distribute a transmission load across the sidelink channel.

In some examples, the UE 705a may prioritize a KPI 730 associated with avoiding aggressive channel access and/or channel load. In other words, the UE 705a may prioritize an increase in data throughput for sidelink transmissions by considering KPIs 730 associated with data rate (such as by prioritizing a peak data rate and/or an effective data rate).

In some examples, the UE 705a may prioritize a KPI 730 associated with prioritizing reliability of sidelink communications. For example, a KPI 730 may prioritize increasing a packet delivery success rate (PDSR) at the UE 705a, reducing a HARQ retransmission rate, and/or increasing reliability of one or more sidelinks 710.

In some examples, the UE 705a may prioritize a KPI 730 associated with reducing latency for sidelink transmissions. For example, a KPI 730 may prioritize reducing transmission latency, reducing scheduling delay, and/or reducing propagation delay.

In some examples, the UE 705a may select and/or compute the one or more KPIs 730 for input into the inference model 720 based on a preference or capability of the UE. In some examples, the UE 705a may transmit the one or more KPIs 730 that are inputted into the inference model 720 to the other UEs 705 and/or to an associated network node. In some examples, the UE 705a may receive one or more sidelink messages from the other UEs 705 that indicate one or more KPIs 730 in use at the other UEs 705. In some examples, the UE 705a may select and/or update the one or more KPIs 730 inputted to the inference model 720 based on the one or more KPIs 730 in use at the other UEs 705. Therefore, the inference model 720 may select/output the one or more parameter values 740 in accordance with the one or more KPIs 730.

In some examples, the inference model 720 may be an AI/ML model, or another type of model. For example, the inference model 720 may be associated with a neural network (e.g., convolutional neural networks (CNNs), recurrent neural networks (RNNs), and/or long short-term memory networks (LSTMs). Additionally, or alternatively, the inference model 720 may be associated with reinforcement learning models (e.g., Q-learning and/or deep Q-networks (DQNs)).

In some examples, the UE 705a may train, retrain, and/or fine-tune operations of the inference model 720 in accordance with the data 725 and/or the KPIs 730 described herein. For instance, the UE 705a may train, retrain, and/or fine-tune operations of the inference model 720 using data collected from data collection 715a, 715b, and/or 715c, using the one or more KPIs 730 selected at the UE, and/or using one or more KPIs 730 indicated by the other UEs 705.

Therefore, the UE 705a may obtain one or more flexible parameters 735 (e.g., via RRC signaling from a network node and/or preconfigured via an OEM configuration). Additionally, the UE 705a may perform Mode 2 sidelink resource selection using one or more parameter values 740 output from the inference model 720.

Additionally, the one or more parameter values 740 may be based on the data 725, the one or more KPIs 730, and the one or more flexible parameters 735 that the UE 705a inputs into the inference model 720.

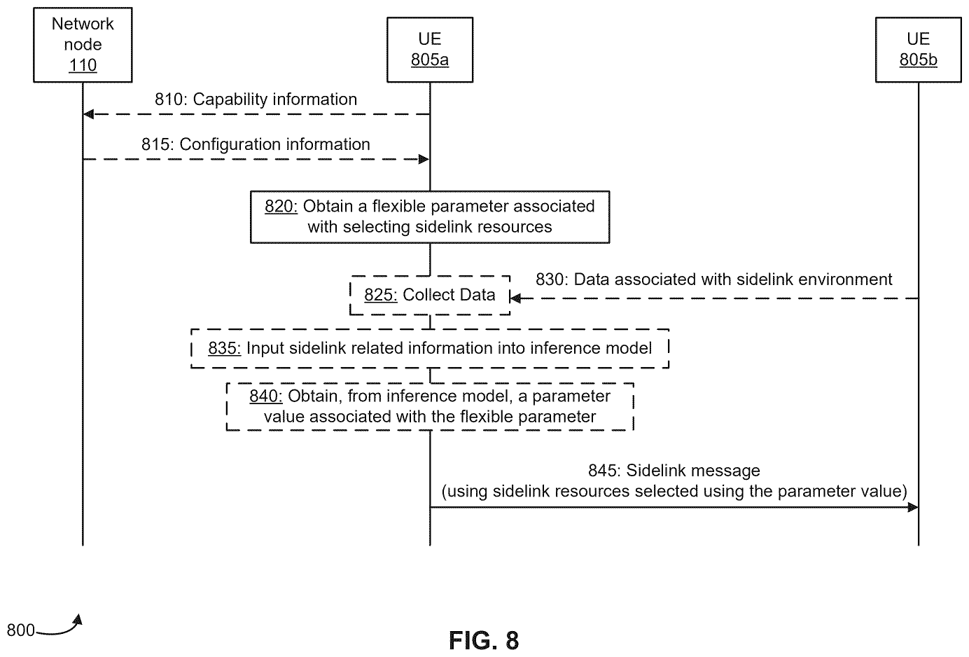

FIG. 8 is a diagram illustrating an example 800 associated with sidelink resource selection associated with a flexible parameter, in accordance with the present disclosure. Example 800 may implement or be implemented by one or more aspects of FIGS. 1 through 7. For instance, example 800 includes wireless communications between the network node 110, a UE 805a and a UE 805b. In some examples, the UE 805a and the UE 805b may respectively correspond to one or more other UEs described elsewhere herein, such as UE 120, UE 305-1, UE 305-2, Tx/Rx UE 405, Rx/Tx UE 410, UE 605, or a UE 705. Alternative examples of the following may be implemented, where some operations are performed in a different order than described, or not described at all. In some cases, one or more operations may include additional features not mentioned below, or further operations may be added. In addition, while example 800 shows operations between two UEs 805 and the network node 110, the communication may occur between any number of network devices of various types described herein.

In some aspects, as shown by first operation 810, the UE 805a may optionally transmit, and the network node 110 may receive, capability information. The capability information may be included in a capability report. The UE 805a may transmit the capability information via an uplink communication, a sidelink communication, a unicast communication, a broadcast communication, a UE assistance information (UAI) communication, a UCI communication, an SCI communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the UE 805a. The one or more parameters may be indicated via respective information elements (IEs) included in a capability report.

The capability information may indicate whether the UE 805a supports a feature and/or one or more parameters related to the feature. For example, the capability information may indicate a capability and/or parameter for supporting the use of flexible parameters (such as flexible parameters 735) associated with selecting resources for sidelink communications as part of a Mode 2 sidelink resource selection.

In some examples, the capability information may indicate a capability and/or parameter for supporting an inference model (such as inference model 720) for selecting a parameter value (such as parameter value 740) from a plurality of parameters associated with a flexible parameter. One or more operations described herein may be based on capability information. For example, the UE 805a may perform a communication or operations at an associated inference model in accordance with the capability information or may receive configuration information that is in accordance with the capability information.

The network node 110 may determine configuration information for the UE 805a based on the capability information. For example, the network node 110 may determine that the UE 805a is to be configured with one or more flexible parameters associated with selecting resources for sidelink communications based on the capability information indicating that the UE 805a supports the flexible parameters. In some examples, the network node may determine that the UE 805a is to be enabled to select parameter values associated with the one or more flexible parameters in accordance with an inference model based on the capability information indicating that the UE 805a supports an inference model for selecting the parameter values. In other examples, the network node 110 may determine the configuration information without, or independently of, the capability information. For example, the network node 110 may determine that the UE 805a supports the use of flexible parameters based on a type, category, or other classification of the UE 805a.

In a second operation 810, the network node 110 may optionally transmit, and the UE 805a may receive, the configuration information. In some aspects, the UE 805a may receive the configuration information via one or more of system information signaling (e.g., a master information block (MIB) and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 805a. For example, in some aspects, the configuration information may at least partially be defined by a wireless communication standard, such as the 3GPP. In such examples, the network node 110 may not explicitly indicate such configuration information to the UE 805a. For example, the UE 805a may optionally obtain at least a portion of the configuration information from a configuration stored by the UE 805a (e.g., an OEM configuration). In some aspects, the configuration information may include a parameter or index that is indicative of information defined, or otherwise fixed, by a wireless communication standard, such as the 3GPP (e.g., rather than explicitly indicating the information).

In a third operation 820, the UE 805a may obtain a flexible parameter associated with selecting resources for sidelink communications, where the flexible parameter is associated with a plurality of parameter values. For example, as described herein, the UE 805a may obtain the flexible parameter based on configuration information from the network node 110 (such as RRC signaling as part of the second operation 815) and/or from memory of the UE 805a (e.g., in accordance with an OEM configuration information). Additionally, the UE 805a may obtain multiple flexible parameters associated with selecting resources for sidelink communications, where each of the multiple flexible parameters are respectively associated with multiple pluralities of parameter values. Therefore, aspects herein that describe operations with a single flexible parameter may be applied to multiple flexible parameters.

In some examples, the flexible parameter is from a set of flexible parameters included in the configuration information. Additionally, the set of flexible parameters may include one or more parameters described elsewhere herein. For example, the set of flexible parameters may include a flexible threshold associated with received signal power for neighboring sidelink communications, where the flexible threshold is associated with a range of threshold values (e.g., sl-Thres-RSRP-List-r16). The set of flexible parameters may include a flexible sensing window associated with sensing the neighboring sidelink communications, where the flexible sensing window is associated with a range of durations (e.g., sl-SensingWindow-r16). The set of flexible parameters may include a first flexible integer number associated with unavailable sidelink resources, where the first flexible integer number is associated with a first range of integer numbers (e.g., sl-TxPercentage-r16). The set of flexible parameters may include a flexible step size associated with incrementing the flexible threshold, where the flexible step size is associated with a range of step sizes or a set of step sizes (e.g., sl-adaptableStepSize). The set of flexible parameters may include a first flexible period associated with a periodic reservation for reserving sidelink resources, where the first flexible period is associated with a set of flexible periods (e.g., sl-ResourceReservePeriodList-r16). The set of flexible parameters may include a second flexible period associated with skipping the periodic reservation for reserving sidelink resources, where the second flexible period is associated with a set of flexible periods (e.g., sl-ResourceReservePeriodSkip-AI). The set of flexible parameters may include a second flexible integer number associated with a maximum number of sidelink resources that can be reserved, where the second flexible integer number is associated with a second range of integer numbers (e.g., sl-MaxNumPerReserve-r16). The set of flexible parameters may include a flexible distance range associated with sidelink communication, where the flexible distance range is associated with a set of distance ranges (e.g., sl-TransRange-r16).

In some examples, the UE 805a may obtain one or more operation parameters that respectively enable or disable one or more operations associated with the sidelink communications. For example, the UE 805a may obtain a set of operation parameters as described elsewhere herein. The set of operation parameters may include a first operation parameter that indicates whether an inference model at the UE 805a is enabled to output a set of traffic periodicities associated with excluding sidelink resources from use in sidelink communications (e.g., sl-step5periodictyDisable). The set of operation parameters may include a second operation parameter that indicates whether pre-emption is enabled for a sidelink resource pool associated with the sidelink communications (e.g., sl-PreemptionEnable). The set of operation parameters may include a third operation parameter that indicates whether a MAC layer is enabled to operate in accordance with the inference model for selection of the set of sidelink resources (e.g., sl-AiRscSelection). The set of operation parameters may include a fourth operation parameter that indicates whether the UE 805a is enabled to select the set of sidelink resources in accordance with the inference model (e.g., sl-MultiReserveResourceAI).

In a fourth operation 825, the UE 805a may collect data associated with the sidelink environment (such as data 725). In some examples, the UE 805a may collect data associated with the sidelink via one or more sensors associated with the UE 805a, such as the one or more sensors described elsewhere herein. For example, the data collected via the one or more sensors may include information associated with a physical environment of the UE 805a, a predicted sidelink quality metric associated with the physical environment of the UE 805a, an indicator associated with a predicted presence or absence of other sidelink UEs 805 (such as the UE 805b), information associated with one or more objects within a geographic location relative to the UE 805a, information associated with one or more mobility characteristics of the UE 805a, or information associated with a behavior of a user associated with the UE 805a. In some examples, the fourth operation 825 may be associated with other data collection techniques described herein (such as data collection 715).

In some examples, the UE 805a may receive data from other UEs 805 associated with the sidelink environment as part of the collecting data in the fourth operation 825. For example, in a fifth operation 830 the UE 805b may optionally transmit, and the UE 805a may receive, data associated with the sidelink environment. In some examples, the data received from the UE 805b may include one or more of information collected by the UE 805b associated with one or more sidelink resource selection procedures performed at the UE 805b, or an indication of one or more collision probability metrics associated with one or more respective sidelink resources.

In a sixth operation 835, the UE 805a may input, into an inference model at the UE 805a, the data associated with the sidelink environment, one or more KPIs (such as the one or more KPIs 730), and the plurality of parameter values associated with the flexible parameter. In some examples, the inference model is the inference model 720.

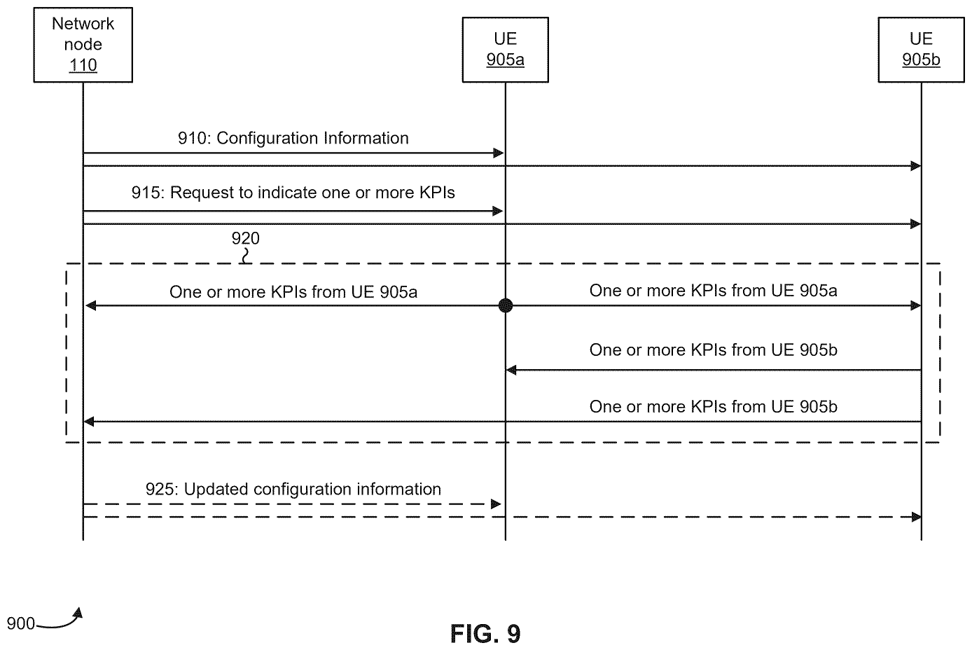

In some examples, the one or more KPIs may include one or more of a quality of service metric associated with the sidelink communications, a data throughput metric associated with the sidelink communications, a channel occupancy metric associated with the sidelink communications, a link reliability metric associated with the sidelink communications, a latency metric associated with the sidelink communications, or any other example of a KPI described elsewhere herein. In some examples, the one or more KPIs of the UE 805a may be associated with and/or influenced by one or more KPIs indicated by other UEs 805 (such as indicated by the UE 805b). Further description of the UEs 805 communicating indications of one or more KPIs is provided elsewhere herein, including with reference to FIG. 9.

In a seventh operation 840, the UE 805a may obtain, from the inference model, the parameter value based on the data associated with the sidelink environment and one or more KPIs. That is, the inference model uses the data and the one or more KPIs to select a parameter value from the plurality of parameter values associated with the flexible parameter.

In some examples, the UE 805a may train the inference model in accordance with one or more of the data associated with the sidelink environment, previous data associated with a previous sidelink environment, the one or more KPIs, or one or more other KPIs received from one or more other UEs 805.

In an eighth operation 845, the UE 805a may transmit, and the UE 805b may receive a sidelink message. In some examples, the UE 805a may transmit the sidelink message via a set of sidelink resources. For example, the set of sidelink resources may be selected in accordance with the parameter value from the plurality of parameter values.

As indicated above, FIG. 8 is provided as an example. Other examples may differ from what is described with regard to FIG. 8.

FIG. 9 is a diagram illustrating an example 900 associated with sidelink resource selection associated with a flexible parameter, in accordance with the present disclosure. Example 900 may implement or be implemented by one or more aspects of FIGS. 1 through 8. For instance, example 900 includes wireless communications between the network node 110, a UE 905a and a UE 905b. In some examples, the UE 905a and the UE 905b may respectively correspond to one or more other UEs described elsewhere herein, such as UE 120, UE 305-1, UE 305-2, Tx/Rx UE 405, Rx/Tx UE 410, UE 605, a UE 705, or a UE 805. Alternative examples of the following may be implemented, where some operations are performed in a different order than described, or not described at all. In some cases, one or more operations may include additional features not mentioned below, or further operations may be added. In addition, while example 900 shows operations between two UEs 905 and the network node 110, the communication may occur between any number of network devices of various types described herein.

In a first operation 910, the network node 110 may transmit, and the UE 905a and/or the UE 905b may receive, respective configuration information. In some cases, the configuration information may be an example of the configuration information described with reference to the first operation 810. In other words, the network node 110 may configure the UE 905a and/or the UE 905b with respective flexible parameters associated with selecting resources for sidelink communications.

In a second operation 915, the network node 110 may transmit, and the UE 905a and/or the UE 905b may receive, respective requests associated with indicating one or more KPIs (such as one or more KPIs 730). For example, the network node 110 may request for the UE 905a to indicate one or more KPIs used by the UE 905a and/or request for the UE 905b to indicate one or more KPIs.

In some examples, the request further indicates for a report of the one or more KPIs to one or more of the network node 110 or one or more other UEs associated with the sidelink communications. For instance, the request transmitted to the UE 905a may request the UE 905a to transmit, to the network node 110 and/or the UE 905b, the indication of the one or more KPIs in use at the UE 905a. Additionally, the request transmitted to the UE 905b may request the UE 905b to transmit, to the network node 110 and/or the UE 905a, the indication of the one or more KPIs in use at the UE 905b.

In a third operation 920, the UE 905a and/or the UE 905b may transmit a report of the one or more KPIs in accordance with the request. In some examples, the UE 905a may transmit, and the network node 110 may receive, a first report that indicates the one or more KPIs in use at the UE 905a (e.g., via PUCCH or PUSCH). In some examples, the UE 905a may transmit, and the UE 905b may receive, a second report that indicates the one or more KPIs in use at the UE 905a (e.g., via PSCCH, PSSCH, or PSFCH as a sidelink groupcast or a sidelink unicast message). In some examples, the UE 905b may transmit, and the network node 110 may receive, a third report that indicates the one or more KPIs in use at the UE 905b (e.g., via PUCCH or PUSCH). In some examples, the UE 905b may transmit, and the UE 905a may receive, a fourth report that indicates the one or more KPIs in use at the UE 905b (e.g., via PSCCH, PSSCH, or PSFCH as a sidelink groupcast or a sidelink unicast message).

In other words, in accordance with example 900, the network node 110 may collect/configure one or more UEs performing sidelink operations to report performance KPIs. In some examples, the network node 110 may use the KPIs received from the UE 905a and/or the UE 905b to determine a native AI performance. For instance, the network node 110 may use the one or more KPIs reported by the UE 905a to determine one or more performance metrics associated with an inference model at the UE 905a (e.g., the inference model 720).

In a fourth operation 925, the network node 110 may optionally transmit, and the UE 905a and/or the UE 905b may receive, respective updated configuration information. For example, the updated configuration information transmitted to the UE 905a may indicate an updated plurality of parameter values associated with the flexible parameter based on the one or more KPIs indicated in the first report or the third report.

As indicated above, FIG. 9 is provided as an example. Other examples may differ from what is described with regard to FIG. 9.

FIG. 10 is a diagram illustrating an example process 1000 performed, for example, at a first UE or an apparatus of a first UE, in accordance with the present disclosure. Example process 1000 is an example where the apparatus or the first UE (e.g., UE 120) performs operations associated with sidelink resource selection in accordance with a flexible parameter configuration.

As shown in FIG. 10, in some aspects, process 1000 may include obtaining configuration information that includes a flexible parameter associated with selecting resources for sidelink communications, wherein the flexible parameter is associated with a plurality of parameter values (block 1010). For example, the first UE (e.g., using reception component 1202 and/or communication manager 1206, depicted in FIG. 12) may obtain configuration information that includes a flexible parameter associated with selecting resources for sidelink communications, wherein the flexible parameter is associated with a plurality of parameter values, as described above.

As further shown in FIG. 10, in some aspects, process 1000 may include transmitting, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more KPIs associated with the sidelink environment (block 1020). For example, the first UE (e.g., using transmission component 1204 and/or communication manager 1206, depicted in FIG. 12) may transmit, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more KPIs associated with the sidelink environment, as described above.

Process 1000 may include additional aspects, such as any single aspect or any combination of aspects described below and/or in connection with one or more other processes described elsewhere herein.

In a first aspect, process 1000 includes inputting, into an inference model at the first UE, the data associated with the sidelink environment, the one or more KPIs, and the plurality of parameter values associated with flexible parameter, and obtaining, from the inference model, the parameter value based at least in part on the data associated with the sidelink environment and the one or more KPIs.

In a second aspect, alone or in combination with the first aspect, process 1000 includes training the inference model in accordance with one or more of the data associated with the sidelink environment, previous data associated with a previous sidelink environment, the one or more KPIs, or one or more other KPIs received from one or more UEs.

In a third aspect, alone or in combination with one or more of the first and second aspects, the flexible parameter is from a set of flexible parameters included in the configuration information, and the set of flexible parameters includes one or more of a flexible threshold associated with received signal power for neighboring sidelink communications, wherein the flexible threshold is associated with a range of threshold values, a flexible sensing window associated with sensing the neighboring sidelink communications, wherein the flexible sensing window is associated with a range of durations, a first flexible integer number associated with unavailable sidelink resources, wherein the first flexible integer number is associated with a first range of integer numbers, a flexible step size associated with incrementing the flexible threshold, wherein the flexible step size is associated with a range of step sizes or a set of step sizes, a first flexible period associated with a periodic reservation for reserving sidelink resources, wherein the first flexible period is associated with a set of flexible periods, a second flexible period associated with skipping the periodic reservation for reserving sidelink resources, wherein the second flexible period is associated with a set of flexible periods, a second flexible integer number associated with a maximum number of sidelink resources that can be reserved, wherein the second flexible integer number is associated with a second range of integer numbers, or a flexible distance range associated with sidelink communication, wherein the flexible distance range is associated with a set of distance ranges.

In a fourth aspect, alone or in combination with one or more of the first through third aspects, the first UE further obtains, as part of the configuration information, an operation parameter that enables or disables one or more operations associated with the sidelink communications.

In a fifth aspect, alone or in combination with one or more of the first through fourth aspects, the operation parameter is from a set of operation parameters included in the configuration information, and the set of operation parameters includes one or more of a first operation parameter that indicates whether an inference model at the first UE is enabled to output a set of traffic periodicities associated with excluding sidelink resources from use in sidelink communications, a second operation parameter indicates whether pre-emption is enabled for a sidelink resource pool associated with the sidelink communications, a third operation parameter that indicates whether a MAC layer is enabled to operate in accordance with the inference model for selection of the set of sidelink resources, or a fourth operation parameter that indicates whether the first UE is enabled to select the set of sidelink resources in accordance with the inference model.

In a sixth aspect, alone or in combination with one or more of the first through fifth aspects, process 1000 includes collecting, via one or more sensors associated with the first UE, the data associated with the sidelink environment.

In a seventh aspect, alone or in combination with one or more of the first through sixth aspects, the data associated with the sidelink environment collected by the one or more sensors includes one or more of information associated with a physical environment of the first UE, a predicted sidelink quality metric the physical environment of the first UE, an indicator associated with a predicted presence or absence of other sidelink UEs, information associated with one or more objects within a geographic location relative to the first UE, information associated with one or more one or more mobility characteristics of the first UE, or information associated with a behavior of a user associated with the first UE.

In an eighth aspect, alone or in combination with one or more of the first through seventh aspects, process 1000 includes receiving, from the second UE, the data associated with the sidelink environment.

In a ninth aspect, alone or in combination with one or more of the first through eighth aspects, the data associated with the sidelink environment received from the second UE includes one or more of information collected by the second UE associated with one or more sidelink resource selection procedures performed at the second UE, or an indication of one or more collision probability metrics associated with respective one or more sidelink resources.

In a tenth aspect, alone or in combination with one or more of the first through ninth aspects, process 1000 includes receiving, from a network node, a request to indicate the one or more KPIs, and transmitting, to one or more of the network node or the second UE, a report that indicates the one or more KPIs in accordance with request.

In an eleventh aspect, alone or in combination with one or more of the first through tenth aspects, process 1000 includes receiving, from the second UE, one or more second KPIs associated with the second UE, wherein the parameter value is based at least in part on the one or more second KPIs.

In a twelfth aspect, alone or in combination with one or more of the first through eleventh aspects, the one or more KPIs include one or more of a quality of service metric associated with the sidelink communications, a data throughput metric associated with the sidelink communications, a channel occupancy metric associated with the sidelink communications, a link reliability metric associated with the sidelink communications, or a latency metric associated with the sidelink communications.

In a thirteenth aspect, alone or in combination with one or more of the first through twelfth aspects, the configuration information is obtained in accordance with receiving RRC signaling from a network node.

In a fourteenth aspect, alone or in combination with one or more of the first through thirteenth aspects, the configuration information is obtained from memory at the first UE, and the configuration information is part of an OEM configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with sidelink resource selection in accordance with a flexible parameter configuration.

As shown in FIG. 11, in some aspects, process 1100 may include transmitting, to a UE, configuration information that includes a flexible parameter associated with selecting resources for sidelink communications, wherein the flexible parameter is associated with a plurality of parameter values (block 1110). For example, the network node (e.g., using transmission component 1304 and/or communication manager 1306, depicted in FIG. 13) may transmit, to a UE, configuration information that includes a flexible parameter associated with selecting resources for sidelink communications, wherein the flexible parameter is associated with a plurality of parameter values, as described above.

As further shown in FIG. 11, in some aspects, process 1100 may include transmitting, to the UE, a request to indicate one or more KPIs used by the UE to select a parameter value from the plurality of parameter values associated with the flexible parameter (block 1120). For example, the network node (e.g., using transmission component 1304 and/or communication manager 1306, depicted in FIG. 13) may transmit, to the UE, a request to indicate one or more KPIs used by the UE to select a parameter value from the plurality of parameter values associated with the flexible parameter, as described above.

Process 1100 may include additional aspects, such as any single aspect or any combination of aspects described below and/or in connection with one or more other processes described elsewhere herein.

In a first aspect, the request further indicates for the UE to indicate the one or more KPIs to one or more of the network node or one or more other UEs associated with the sidelink communications.

In a second aspect, alone or in combination with the first aspect, process 1100 includes receiving, from the UE, a report that indicates the one or more KPIs in accordance with the request.

In a third aspect, alone or in combination with one or more of the first and second aspects, process 1100 includes transmitting, to the UE, updated configuration information that indicates an updated plurality of parameter values associated with the flexible parameter based at least in part on the one or more KPIs indicated in the report.

In a fourth aspect, alone or in combination with one or more of the first through third aspects, the flexible parameter is from a set of flexible parameters included in the configuration information, and the set of flexible parameters includes one or more of a flexible threshold associated with received signal power for neighboring sidelink communications, wherein the flexible threshold is associated with a range of threshold values, a flexible sensing window associated with sensing the neighboring sidelink communications, wherein the flexible sensing window is associated with a range of durations, a first flexible integer number associated with unavailable sidelink resources, wherein the first flexible integer number is associated with a first range of integer numbers, a flexible step size associated with incrementing the flexible threshold, wherein the flexible step size is associated with a range of step sizes or a set of step sizes, a first flexible period associated with a periodic reservation for reserving sidelink resources, wherein the first flexible period is associated with a set of flexible periods, a second flexible period associated with skipping the periodic reservation for reserving sidelink resources, wherein the second flexible period is associated with a set of flexible periods, a second flexible integer number associated with a maximum number of sidelink resources that can be reserved, wherein the second flexible integer number is associated with a second range of integer numbers, or a flexible distance range associated with sidelink communication, wherein the flexible distance range is associated with a set of distance ranges.

In a fifth aspect, alone or in combination with one or more of the first through fourth aspects, the configuration information further includes an operation parameter that enables or disables one or more operations associated with the sidelink communications.

In a sixth aspect, alone or in combination with one or more of the first through fifth aspects, the operation parameter is from a set of operation parameters included in the configuration information, and the set of operation parameters includes one or more of a first operation parameter that indicates whether an inference model at the UE is enabled to output a set of traffic periodicities associated with excluding sidelink resources from use in sidelink communications, a second operation parameter indicates whether pre-emption is enabled for a sidelink resource pool associated with the sidelink communications, a third operation parameter that indicates whether a MAC layer is enabled to operate in accordance with the inference model for selection of the set of sidelink resources, or a fourth operation parameter that indicates whether the UE is enabled to select the set of sidelink resources in accordance with the inference model.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a first UE, or a first UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the first UE.

In some aspects, the apparatus 1200 may be configured to perform one or more operations described herein in connection with FIGS. 3 through 9 Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the first UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the first UE described above in connection with FIG. 1, such as a radio, one or more RF chains, one or more transceivers, or one or more modems, each of which may in turn be coupled with one or more antennas of the first UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the first UE described above in connection with FIG. 1, such as a radio, one or more RF chains, one or more transceivers, or one or more modems, each of which may in turn be coupled with one or more antennas of the first UE described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may obtain configuration information that includes a flexible parameter associated with selecting resources for sidelink communications, wherein the flexible parameter is associated with a plurality of parameter values. The transmission component 1204 may transmit, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more KPIs associated with the sidelink environment.

The communication manager 1206 may input, into an inference model at the first UE, the data associated with the sidelink environment, the one or more KPIs, and the plurality of parameter values associated with flexible parameter.

The reception component 1202 may obtain, from the inference model, the parameter value based at least in part on the data associated with the sidelink environment and the one or more KPIs.

The communication manager 1206 may train the inference model in accordance with one or more of the data associated with the sidelink environment, previous data associated with a previous sidelink environment, the one or more KPIs, or one or more other KPIs received from one or more UEs.

The communication manager 1206 may collect, via one or more sensors associated with the first UE, the data associated with the sidelink environment.

The reception component 1202 may receive, from the second UE, the data associated with the sidelink environment.

The reception component 1202 may receive, from a network node, a request to indicate the one or more KPIs.

The transmission component 1204 may transmit, to one or more of the network node or the second UE, a report that indicates the one or more KPIs in accordance with request.

The reception component 1202 may receive, from the second UE, one or more second KPIs associated with the second UE, wherein the parameter value is based at least in part on the one or more second KPIs.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network node.

In some aspects, the apparatus 1300 may be configured to perform one or more operations described herein in connection with FIGS. 3 through 9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, to a UE, configuration information that includes a flexible parameter associated with selecting resources for sidelink communications, wherein the flexible parameter is associated with a plurality of parameter values. The transmission component 1304 may transmit, to the UE, a request to indicate one or more KPIs used by the UE to select a parameter value from the plurality of parameter values associated with the flexible parameter.

The reception component 1302 may receive, from the UE, a report that indicates the one or more KPIs in accordance with the request.

The transmission component 1304 may transmit, to the UE, updated configuration information that indicates an updated plurality of parameter values associated with the flexible parameter based at least in part on the one or more KPIs indicated in the report.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a first user equipment (UE), comprising: obtaining configuration information that includes a flexible parameter associated with selecting resources for sidelink communications, wherein the flexible parameter is associated with a plurality of parameter values; and transmitting, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more key performance indicators (KPIs) associated with the sidelink environment.
Aspect 2: The method of Aspect 1, further comprising: inputting, into an inference model at the first UE, the data associated with the sidelink environment, the one or more KPIs, and the plurality of parameter values associated with flexible parameter; and obtaining, from the inference model, the parameter value based at least in part on the data associated with the sidelink environment and the one or more KPIs.
Aspect 3: The method of Aspect 2, further comprising: training the inference model in accordance with one or more of the data associated with the sidelink environment, previous data associated with a previous sidelink environment, the one or more KPIs, or one or more other KPIs received from one or more UEs.
Aspect 4: The method of any of Aspects 1-3, wherein the flexible parameter is from a set of flexible parameters included in the configuration information, and wherein the set of flexible parameters includes one or more of: a flexible threshold associated with received signal power for neighboring sidelink communications, wherein the flexible threshold is associated with a range of threshold values, a flexible sensing window associated with sensing the neighboring sidelink communications, wherein the flexible sensing window is associated with a range of durations, a first flexible integer number associated with unavailable sidelink resources, wherein the first flexible integer number is associated with a first range of integer numbers, a flexible step size associated with incrementing the flexible threshold, wherein the flexible step size is associated with a range of step sizes or a set of step sizes, a first flexible period associated with a periodic reservation for reserving sidelink resources, wherein the first flexible period is associated with a set of flexible periods, a second flexible period associated with skipping the periodic reservation for reserving sidelink resources, wherein the second flexible period is associated with a set of flexible periods, a second flexible integer number associated with a maximum number of sidelink resources that can be reserved, wherein the second flexible integer number is associated with a second range of integer numbers, or a flexible distance range associated with sidelink communication, wherein the flexible distance range is associated with a set of distance ranges.
Aspect 5: The method of any of Aspects 1-4, wherein the first UE further obtains, as part of the configuration information, an operation parameter that enables or disables one or more operations associated with the sidelink communications.
Aspect 6: The method of Aspect 5, wherein the operation parameter is from a set of operation parameters included in the configuration information, and wherein the set of operation parameters includes one or more of: a first operation parameter that indicates whether an inference model at the first UE is enabled to output a set of traffic periodicities associated with excluding sidelink resources from use in sidelink communications, a second operation parameter indicates whether pre-emption is enabled for a sidelink resource pool associated with the sidelink communications, a third operation parameter that indicates whether a medium access control (MAC) layer is enabled to operate in accordance with the inference model for selection of the set of sidelink resources, or a fourth operation parameter that indicates whether the first UE is enabled to select the set of sidelink resources in accordance with the inference model.
Aspect 7: The method of any of Aspects 1-6, further comprising: collecting, via one or more sensors associated with the first UE, the data associated with the sidelink environment.
Aspect 8: The method of Aspect 7, wherein the data associated with the sidelink environment collected by the one or more sensors includes one or more of: information associated with a physical environment of the first UE, a predicted sidelink quality metric the physical environment of the first UE, an indicator associated with a predicted presence or absence of other sidelink UEs, information associated with one or more objects within a geographic location relative to the first UE, information associated with one or more one or more mobility characteristics of the first UE, or information associated with a behavior of a user associated with the first UE.
Aspect 9: The method of any of Aspects 1-8, further comprising: receiving, from the second UE, the data associated with the sidelink environment.
Aspect 10: The method of Aspect 9, wherein the data associated with the sidelink environment received from the second UE includes one or more of: information collected by the second UE associated with one or more sidelink resource selection procedures performed at the second UE, or an indication of one or more collision probability metrics associated with respective one or more sidelink resources.
Aspect 11: The method of any of Aspects 1-10, further comprising: receiving, from a network node, a request to indicate the one or more KPIs; and transmitting, to one or more of the network node or the second UE, a report that indicates the one or more KPIs in accordance with request.
Aspect 12: The method of any of Aspects 1-11, further comprising: receiving, from the second UE, one or more second KPIs associated with the second UE, wherein the parameter value is based at least in part on the one or more second KPIs.
Aspect 13: The method of any of Aspects 1-12, wherein the one or more KPIs include one or more of: a quality of service metric associated with the sidelink communications, a data throughput metric associated with the sidelink communications, a channel occupancy metric associated with the sidelink communications, a link reliability metric associated with the sidelink communications, or a latency metric associated with the sidelink communications.
Aspect 14: The method of any of Aspects 1-13, wherein the configuration information is obtained in accordance with receiving radio resource control (RRC) signaling from a network node.
Aspect 15: The method of any of Aspects 1-14, wherein the configuration information is obtained from memory at the first UE, and wherein the configuration information is part of an original equipment manufacturer (OEM) configuration.
Aspect 16: A method of wireless communication performed by a network node, comprising: transmitting, to a user equipment (UE), configuration information that includes a flexible parameter associated with selecting resources for sidelink communications, wherein the flexible parameter is associated with a plurality of
parameter values; and transmitting, to the UE, a request to indicate one or more key performance indicators (KPIs) used by the UE to select a parameter value from the plurality of parameter values associated with the flexible parameter.
Aspect 17: The method of Aspect 16, wherein the request further indicates for the UE to indicate the one or more KPIs to one or more of the network node or one or more other UEs associated with the sidelink communications.
Aspect 18: The method of any of Aspects 16-17, further comprising: receiving, from the UE, a report that indicates the one or more KPIs in accordance with the request.
Aspect 19: The method of Aspect 18, further comprising: transmitting, to the UE, updated configuration information that indicates an updated plurality of parameter values associated with the flexible parameter based at least in part on the one or more KPIs indicated in the report.
Aspect 20: The method of any of Aspects 16-19, wherein the flexible parameter is from a set of flexible parameters included in the configuration information, and wherein the set of flexible parameters includes one or more of: a flexible threshold associated with received signal power for neighboring sidelink communications, wherein the flexible threshold is associated with a range of threshold values, a flexible sensing window associated with sensing the neighboring sidelink communications, wherein the flexible sensing window is associated with a range of durations, a first flexible integer number associated with unavailable sidelink resources, wherein the first flexible integer number is associated with a first range of integer numbers, a flexible step size associated with incrementing the flexible threshold, wherein the flexible step size is associated with a range of step sizes or a set of step sizes, a first flexible period associated with a periodic reservation for reserving sidelink resources, wherein the first flexible period is associated with a set of flexible periods, a second flexible period associated with skipping the periodic reservation for reserving sidelink resources, wherein the second flexible period is associated with a set of flexible periods, a second flexible integer number associated with a maximum number of sidelink resources that can be reserved, wherein the second flexible integer number is associated with a second range of integer numbers, or a flexible distance range associated with sidelink communication, wherein the flexible distance range is associated with a set of distance ranges.
Aspect 21: The method of any of Aspects 16-20, wherein the configuration information further includes an operation parameter that enables or disables one or more operations associated with the sidelink communications.
Aspect 22: The method of Aspect 21, wherein the operation parameter is from a set of operation parameters included in the configuration information, and wherein the set of operation parameters includes one or more of: a first operation parameter that indicates whether an inference model at the UE is enabled to output a set of traffic periodicities associated with excluding sidelink resources from use in sidelink communications, a second operation parameter indicates whether pre-emption is enabled for a sidelink resource pool associated with the sidelink communications, a third operation parameter that indicates whether a medium access control (MAC) layer is enabled to operate in accordance with the inference model for selection of the set of sidelink resources, or a fourth operation parameter that indicates whether the UE is enabled to select the set of sidelink resources in accordance with the inference model.
Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.
Aspect 24: An apparatus for wireless communication at a device, the apparatus comprising one or more memories and one or more processors coupled to the one or more memories, the one or more processors configured to cause the device to perform the method of one or more of Aspects 1-22.
Aspect 25: An apparatus for wireless communication, the apparatus comprising at least one means for performing the method of one or more of Aspects 1-22.
Aspect 26: A non-transitory computer-readable medium storing code for wireless communication, the code comprising instructions executable by one or more processors to perform the method of one or more of Aspects 1-22.
Aspect 27: A non-transitory computer-readable medium storing a set of instructions for wireless communication, the set of instructions comprising one or more instructions that, when executed by one or more processors of a device, cause the device to perform the method of one or more of Aspects 1-22.
Aspect 28: A device for wireless communication, the device comprising a processing system that includes one or more processors and one or more memories coupled with the one or more processors, the processing system configured to cause the device to perform the method of one or more of Aspects 1-22.
Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first user equipment (UE) for wireless communication, comprising:
one or more memories; and
one or more processors, coupled to the one or more memories, configured to cause the first UE to:
obtain configuration information that includes a flexible parameter associated with selecting resources for sidelink communications, wherein the flexible parameter is associated with a plurality of parameter values; and
transmit, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more key performance indicators (KPIs) associated with the sidelink environment.

2. The first UE of claim 1, wherein the one or more processors are further configured to cause the first UE to:
input, into an inference model at the first UE, the data associated with the sidelink environment, the one or more KPIs, and the plurality of parameter values associated with flexible parameter; and
obtain, from the inference model, the parameter value based at least in part on the data associated with the sidelink environment and the one or more KPIs.

3. The first UE of claim 2, wherein the one or more processors are further configured to cause the first UE to:
train the inference model in accordance with one or more of the data associated with the sidelink environment, previous data associated with a previous sidelink environment, the one or more KPIs, or one or more other KPIs received from one or more UEs.

4. The first UE of claim 1, wherein the flexible parameter is from a set of flexible parameters included in the configuration information, and wherein the set of flexible parameters includes one or more of:
a flexible threshold associated with received signal power for neighboring sidelink communications, wherein the flexible threshold is associated with a range of threshold values,
a flexible sensing window associated with sensing the neighboring sidelink communications, wherein the flexible sensing window is associated with a range of durations,
a first flexible integer number associated with unavailable sidelink resources, wherein the first flexible integer number is associated with a first range of integer numbers,
a flexible step size associated with incrementing the flexible threshold, wherein the flexible step size is associated with a range of step sizes or a set of step sizes,
a first flexible period associated with a periodic reservation for reserving sidelink resources, wherein the first flexible period is associated with a set of flexible periods,
a second flexible period associated with skipping the periodic reservation for reserving sidelink resources, wherein the second flexible period is associated with a set of flexible periods,
a second flexible integer number associated with a maximum number of sidelink resources that can be reserved, wherein the second flexible integer number is associated with a second range of integer numbers, or
a flexible distance range associated with sidelink communication, wherein the flexible distance range is associated with a set of distance ranges.

5. The first UE of claim 1, wherein the first UE further obtains, as part of the configuration information, an operation parameter that enables or disables one or more operations associated with the sidelink communications.

6. The first UE of claim 5, wherein the operation parameter is from a set of operation parameters included in the configuration information, and wherein the set of operation parameters includes one or more of:
a first operation parameter that indicates whether an inference model at the first UE is enabled to output a set of traffic periodicities associated with excluding sidelink resources from use in sidelink communications,
a second operation parameter indicates whether pre-emption is enabled for a sidelink resource pool associated with the sidelink communications,
a third operation parameter that indicates whether a medium access control (MAC) layer is enabled to operate in accordance with the inference model for selection of the set of sidelink resources, or
a fourth operation parameter that indicates whether the first UE is enabled to select the set of sidelink resources in accordance with the inference model.

7. The first UE of claim 1, wherein the one or more processors are further configured to cause the first UE to:
collect, via one or more sensors associated with the first UE, the data associated with the sidelink environment.

8. The first UE of claim 7, wherein the data associated with the sidelink environment collected by the one or more sensors includes one or more of:
information associated with a physical environment of the first UE,
a predicted sidelink quality metric the physical environment of the first UE,
an indicator associated with a predicted presence or absence of other sidelink UEs, information associated with one or more objects within a geographic location relative to the first UE,
information associated with one or more one or more mobility characteristics of the first UE, or
information associated with a behavior of a user associated with the first UE.

9. The first UE of claim 1, wherein the one or more processors are further configured to cause the first UE to:
receive, from the second UE, the data associated with the sidelink environment.

10. The first UE of claim 9, wherein the data associated with the sidelink environment received from the second UE includes one or more of:
information collected by the second UE associated with one or more sidelink resource selection procedures performed at the second UE, or
an indication of one or more collision probability metrics associated with respective one or more sidelink resources.

11. The first UE of claim 1, wherein the one or more processors are further configured to cause the first UE to:
receive, from a network node, a request to indicate the one or more KPIs; and
transmit, to one or more of the network node or the second UE, a report that indicates the one or more KPIs in accordance with request.

12. The first UE of claim 1, wherein the one or more processors are further configured to cause the first UE to:
receive, from the second UE, one or more second KPIs associated with the second UE,
wherein the parameter value is based at least in part on the one or more second KPIs.

13. The first UE of claim 1, wherein the one or more KPIs include one or more of:
a quality of service metric associated with the sidelink communications,
a data throughput metric associated with the sidelink communications,
a channel occupancy metric associated with the sidelink communications,
a link reliability metric associated with the sidelink communications, or
a latency metric associated with the sidelink communications.

14. The first UE of claim 1, wherein the configuration information is obtained in accordance with receiving radio resource control (RRC) signaling from a network node.

15. The first UE of claim 1, wherein the configuration information is obtained from memory at the first UE, and wherein the configuration information is part of an original equipment manufacturer (OEM) configuration.

16. A network node for wireless communication, comprising:
one or more memories; and
one or more processors, coupled to the one or more memories, configured to cause the network node to:
transmit, to a user equipment (UE), configuration information that includes a flexible parameter associated with selecting resources for sidelink communications, wherein the flexible parameter is associated with a plurality of parameter values; and
transmit, to the UE, a request to indicate one or more key performance indicators (KPIs) used by the UE to select a parameter value from the plurality of parameter values associated with the flexible parameter.

17. The network node of claim 16, wherein the request further indicates for the UE to indicate the one or more KPIs to one or more of the network node or one or more other UEs associated with the sidelink communications.

18. The network node of claim 16, wherein the one or more processors are further configured to cause the network node to:
receive, from the UE, a report that indicates the one or more KPIs in accordance with the request.

19. The network node of claim 18, wherein the one or more processors are further configured to cause the network node to:
transmit, to the UE, updated configuration information that indicates an updated plurality of parameter values associated with the flexible parameter based at least in part on the one or more KPIs indicated in the report.

20. The network node of claim 16, wherein the flexible parameter is from a set of flexible parameters included in the configuration information, and wherein the set of flexible parameters includes one or more of:
a flexible threshold associated with received signal power for neighboring sidelink communications, wherein the flexible threshold is associated with a range of threshold values,
a flexible sensing window associated with sensing the neighboring sidelink communications, wherein the flexible sensing window is associated with a range of durations,
a first flexible integer number associated with unavailable sidelink resources, wherein the first flexible integer number is associated with a first range of integer numbers,
a flexible step size associated with incrementing the flexible threshold, wherein the flexible step size is associated with a range of step sizes or a set of step sizes,
a first flexible period associated with a periodic reservation for reserving sidelink resources, wherein the first flexible period is associated with a set of flexible periods,
a second flexible period associated with skipping the periodic reservation for reserving sidelink resources, wherein the second flexible period is associated with a set of flexible periods,
a second flexible integer number associated with a maximum number of sidelink resources that can be reserved, wherein the second flexible integer number is associated with a second range of integer numbers, or
a flexible distance range associated with sidelink communication, wherein the flexible distance range is associated with a set of distance ranges.

21. The network node of claim 16, wherein the configuration information further includes an operation parameter that enables or disables one or more operations associated with the sidelink communications.

22. The network node of claim 21, wherein the operation parameter is from a set of operation parameters included in the configuration information, and wherein the set of operation parameters includes one or more of:
a first operation parameter that indicates whether an inference model at the UE is enabled to output a set of traffic periodicities associated with excluding sidelink resources from use in sidelink communications,
a second operation parameter indicates whether pre-emption is enabled for a sidelink resource pool associated with the sidelink communications,
a third operation parameter that indicates whether a medium access control (MAC) layer is enabled to operate in accordance with the inference model for selection of the set of sidelink resources, or
a fourth operation parameter that indicates whether the UE is enabled to select the set of sidelink resources in accordance with the inference model.

23. A method of wireless communication performed by a first user equipment (UE), comprising:
obtaining configuration information that includes a flexible parameter associated with selecting resources for sidelink communications, wherein the flexible parameter is associated with a plurality of parameter values; and
transmitting, to a second UE, a sidelink message via a set of sidelink resources, wherein the set of sidelink resources is selected in accordance with a parameter value from the plurality of parameter values, wherein the parameter value is based at least in part on data associated with a sidelink environment and one or more key performance indicators (KPIs) associated with the sidelink environment.

24. The method of claim 23, further comprising:
inputting, into an inference model at the first UE, the data associated with the sidelink environment, the one or more KPIs, and the plurality of parameter values associated with flexible parameter; and
obtaining, from the inference model, the parameter value based at least in part on the data associated with the sidelink environment and the one or more KPIs.

25. The method of claim 24, further comprising:
training the inference model in accordance with one or more of the data associated with the sidelink environment, previous data associated with a previous sidelink environment, the one or more KPIs, or one or more other KPIs received from one or more UEs.

26. The method of claim 23, wherein the flexible parameter is from a set of flexible parameters included in the configuration information, and wherein the set of flexible parameters includes one or more of:
a flexible threshold associated with received signal power for neighboring sidelink communications, wherein the flexible threshold is associated with a range of threshold values,
a flexible sensing window associated with sensing the neighboring sidelink communications, wherein the flexible sensing window is associated with a range of durations,
a first flexible integer number associated with unavailable sidelink resources, wherein the first flexible integer number is associated with a first range of integer numbers,
a flexible step size associated with incrementing the flexible threshold, wherein the flexible step size is associated with a range of step sizes or a set of step sizes,
a first flexible period associated with a periodic reservation for reserving sidelink resources, wherein the first flexible period is associated with a set of flexible periods,
a second flexible period associated with skipping the periodic reservation for reserving sidelink resources, wherein the second flexible period is associated with a set of flexible periods,
a second flexible integer number associated with a maximum number of sidelink resources that can be reserved, wherein the second flexible integer number is associated with a second range of integer numbers, or
a flexible distance range associated with sidelink communication, wherein the flexible distance range is associated with a set of distance ranges.

27. The method of claim 23, wherein the first UE further obtains, as part of the configuration information, an operation parameter that enables or disables one or more operations associated with the sidelink communications.

28. The method of claim 27, wherein the operation parameter is from a set of operation parameters included in the configuration information, and wherein the set of operation parameters includes one or more of:
a first operation parameter that indicates whether an inference model at the first UE is enabled to output a set of traffic periodicities associated with excluding sidelink resources from use in sidelink communications,
a second operation parameter indicates whether pre-emption is enabled for a sidelink resource pool associated with the sidelink communications,
a third operation parameter that indicates whether a medium access control (MAC) layer is enabled to operate in accordance with the inference model for selection of the set of sidelink resources, or
a fourth operation parameter that indicates whether the first UE is enabled to select the set of sidelink resources in accordance with the inference model.

29. The method of claim 23, further comprising:
collecting, via one or more sensors associated with the first UE, the data associated with the sidelink environment.

30. A method of wireless communication performed by a network node, comprising:
transmitting, to a user equipment (UE), configuration information that includes a flexible parameter associated with selecting resources for sidelink communications, wherein the flexible parameter is associated with a plurality of parameter values; and
transmitting, to the UE, a request to indicate one or more key performance indicators (KPIs) used by the UE to select a parameter value from the plurality of parameter values associated with the flexible parameter.
